(19) United States
(12) Patent Application Publication
(10) Pub. No.: US 2025/0234298 A1
(43) Pub. Date: Jul. 17, 2025

(54) ENHANCED PUCCH POWER CONTROL WHEN MIXING UCI OF DIFFERENT PRIORITIES

(71) Applicant: TELEFONAKTIEBOLAGET LM ERICSSON (PUBL), STOCKHOLM (SE)

(72) Inventors: Jonas Fröberg Olsson, LJUNGSBRO (SE); Yufei Blankenship, KILDEER, IL (US); Mattias Andersson, SUNDBYBERG (SE)

(21) Appl. No.: 18/697,725

(22) PCT Filed: Oct. 1, 2022
(86) PCT No.: PCT/IB2022/059374

§ 371 Date: Apr. 1, 2024

Related U.S. Application Data
(60) Provisional application No. 63/251,550, filed on Oct. 1, 2021.

(51) Int. Cl. H04W 52/14; H04L 5/00; H04W 72/21

(52) U.S. Cl. CPC H04W 52/146; H04L 5/0055; H04W 72/21

(57) ABSTRACT

Systems and methods for enhanced Physical Uplink Control Channel (PUCCH) power control when missing Uplink Control Information (UCI) of different priorities are provided. In some embodiments, a method performed by a User Equipment (UE) for determining a power adjustment includes determining a PUCCH power adjustment with respect to a PUCCH format and/or Transport Format (TF); wherein determining the PUCCH power adjustment is based on one or more out of: a UCI consists of UCI with same priority index or different priority indices; a number of high-priority and/or low-priority UCI bits; and a minimum of high-priority and low-priority UCI bits. In this way, PUCCH power is able to be properly adjusted when UCI consists of UCI with different priority index.

### RELATED APPLICATIONS

This application claims the benefit of provisional patent application Ser. No. 63/251,550, filed Oct. 1, 2021, the disclosure of which is hereby incorporated herein by reference in its entirety.

### TECHNICAL FIELD

The current disclosure relates generally to power adjustment determination.

### BACKGROUND

The next generation mobile wireless communication system (5G) or new radio (NR), will support a diverse set of use cases and a diverse set of deployment scenarios. The later includes deployment at both low frequencies (100s of MHz), similar to LTE today, and very high frequencies (mm waves in the tens of GHz).

Similar to LTE, NR will use OFDM (Orthogonal Frequency Division Multiplexing) in the downlink (i.e., from a network node, gNB, eNB, or base station, to a user equipment or UE). In the uplink (i.e., from UE to gNB), both OFDM and DFT-spread OFDM (DFT-S-OFDM), also known as SC-FDMA in LTE, will be supported. The basic NR physical resource can thus be seen as a time-frequency grid as illustrated in FIG. 1, where a resource block (RB) in a 14-symbol slot is shown. A resource block corresponds to 12 contiguous subcarriers in the frequency domain. Resource blocks are numbered in the frequency domain, starting with 0 from one end of the system bandwidth. Each resource element corresponds to one OFDM subcarrier during one OFDM symbol interval.

Different subcarrier spacing values are supported in NR. The supported subcarrier spacing values (also referred to as different numerologies) are given by Δf=(15×2^{μ}) kHz where p is a non-negative integer and can be one of {0, 1, 2, 3, 4}. Δf=15 kHz (e.g., μ=0) is the basic (or reference) subcarrier spacing that is also used in LTE. μ is also referred to as the numerology.

In the time domain, downlink and uplink transmissions in NR will be organized into equally-sized subframes of 1 ms each similar to LTE. A subframe is further divided into multiple slots of equal duration. The slot length is dependent on the subcarrier spacing or numerology and is given by 1/2^{μ} ms. Each slot consists of 14 OFDM symbols for normal Cyclic Prefix (CP).

It is understood that data scheduling in NR can be in slot basis. An example is shown in FIG. 2 with a 14-symbol slot, where the first two symbols contain control channel (PDCCH) and the rest contains data channel (PDSCH).

Downlink transmissions can be dynamically scheduled, i.e., in each slot the gNB transmits downlink control information (DCI) about which UE data is to be transmitted to and which resource blocks in the current downlink slot the data is transmitted on. This control signaling is typically transmitted in the first one or two OFDM symbols in each slot in NR. The control information is carried on Physical Control Channel (PDCCH) and data is carried on Physical Downlink Shared Channel (PDSCH). A UE first detects and decodes PDCCH and if a PDCCH is decoded successfully, it then decodes the corresponding PDSCH based on the decoded control information in the PDCCH.

Uplink data transmission can also be dynamically scheduled using PDCCH. Similar to downlink, a UE first decodes uplink grants in PDCCH and then transmits data over the Physical Uplink Shared Channel (PUSCH) based the decoded control information in the uplink grant such as modulation order, coding rate, uplink resource allocation, etc.

Uplink Control Information (UCI) is a control information sent by a UE to a gNB. It consists of:
Hybrid-ARQ acknowledgement (HARQ-ACK) which is a feedback information corresponding to the received downlink transport block whether the transport block reception is successful or not,
Channel state information (CSI) related to downlink channel conditions which provides gNB with channel-related information useful for DL scheduling, including information for multi-antenna and beamforming schemes, and
Scheduling request (SR) which indicates a need of UL resources for UL data transmission.

UCI is typically transmitted on Physical Uplink Control Channel (PUCCH). However, if a UE is transmitting data on the PUSCH with a valid PUSCH resource overlapping with PUCCH, UCI can be multiplexed with UL data and transmitted on PUSCH instead, if the timeline requirements for UCI multiplexing is met.

PUCCH is used by a UE to transmit HARQ-ACK feedback message corresponding to the reception of DL data transmission. It is also used by the UE to send channel state information (CSI) or to request for an uplink grant for transmitting UL data.

In NR, there exist multiple PUCCH formats supporting different UCI payload sizes. PUCCH formats 0 and 1 support UCI up to 2 bits, while PUCCH formats 2, 3, and 4 can support UCI of more than 2 bits. In terms of PUCCH transmission duration, PUCCH formats 0 and 2 are considered short PUCCH formats supporting PUCCH duration of 1 or 2 OFDM symbols, while PUCCH formats 1, 3, and 4 are considered as long formats and can support PUCCH duration from 4 to 14 symbols.

### PUCCH Power Control

UE behavior for PUCCH power control is described in Section 7.2.1 in 38.213, v16.6.9:

If a UE transmits a PUCCH on active UL BWP b of carrier f in the primary cell c using PUCCH power control adjustment state with index l, the UE determines the PUCCH transmission power P_{PUCCH,b,f,c}(i,qᵤ,q_{d},l) in PUCCH transmission occasion i as

$${P}_{PUCCH , b , f , c} ( i , {q}_{u} , {q}_{d} , l ) = min \{ \begin{matrix}{P}_{CMAX , f , c} ( i ) , \\ \begin{matrix}{P}_{O \_ PUCCH , b , f , c} ( {q}_{u} ) + 10 {log}_{10} ( {2}^{μ} \cdot {M}_{RB , b , f , c}^{PUCCH} ( i ) ) + \\ {PL}_{b , f , c} ( {q}_{d} ) + {Δ}_{F \_ PUCCH} ( F ) + {Δ}_{TF , b , f , c} + {g}_{b , f , c} ( i , l )\end{matrix}\end{matrix} \} [ dBm ]$$

where
P_{CMAX,f,c}(i) is the UE configured maximum output power defined in [8-1, TS 38.101-1], [8-2, TS38.101-2] and [8-3, TS38.101-3] for carrier f of primary cell c in PUCCH transmission occasion i
P_{O_PUCCH,b,f,c}(qᵤ) is a parameter composed of the sum of a component P_{O_NOMINAL_PUCCH}, provided by p0-nominal, or P_{O_NOMINAL_PUCCH}=0 dBm if p0-nominal is not provided, for carrier f of primary cell c and, if provided, a component P_{O_UE_PUCCH}(qᵤ) provided by p0-PUCCH-Value in P0-PUCCH for active UL BWP b of carrier f of primary cell c, where 0≤qᵤ<Qᵤ. Qᵤ is a size for a set of P_{O_UE_UCCH} values provided by maxNrofPUCCH-P0-PerSet. The set of P_{O_UE_PUCCH} values is provided by p0-Set. If p0-Set is not provided to the UE, P_{O_U_PUCCH}(qᵤ)=0, 0≤u≥Qᵤ
   If the UE is provided PUCCH-SpatialRelationInfo, the UE obtains a mapping, by an index provided by p0-PUCCH-Id, between a set of pucch-SpatialRelationInfoId values and a set of p0-PUCCH-Value values. If the UE is provided more than one values for pucch-SpatialRelationInfoId and the UE receives an activation command [11, TS 38.321] indicating a value of pucch-SpatialRelationInfoId, the UE determines the p0-PUCCH-Value value through the link to a corresponding p0-PUCCH-Id index. The UE applies the activation command in the first slot that is after slot k+3·Nₛₗₒₜ^{subframe,μ} where k is the slot where the UE would transmit a PUCCH with HARQ-ACK information for the PDSCH providing the activation command and μ is the SCS configuration for the PUCCH
   If the UE is not provided PUCCH-SpatialRelationInfo, the UE obtains the p0-PUCCH-Value value from the P0-PUCCH with p0-PUCCH-Id value equal to the minimum p0-PUCCH-Id value in p0-Set
M_{RB,b,f,c}^{PUCCH}(i) is a bandwidth of the PUCCH resource assignment expressed in number of resource blocks for PUCCH transmission occasion i on active UL BWP b of carrier f of primary cell c and μ is a SCS configuration defined in [4, TS 38.211]
PL_{b,f,c}(q_{d}) is a downlink pathloss estimate in dB calculated by the UE using RS resource index q_{d} as described in clause 7.1.1 for the active DL BWP b of carrier f of the primary cell c as described in clause 12
   If the UE is not provided pathlossReferenceRSs or before the UE is provided dedicated higher layer parameters, the UE calculates PL_{b,f,c}(q_{d}) using a RS resource obtained from an SS/PBCH block with same SS/PBCH block index as the one the UE uses to obtain MIB
   If the UE is provided a number of RS resource indexes, the UE calculates PL_{b,f,c}(q_{d}) using RS resource with index q_{d}, where 0≤q_{d}<Q_{d}. Q_{d} is a size for a set of RS resources provided by maxNrofPUCCH-PathlossReferenceRSs. The set of RS resources is provided by pathlossReferenceRSs. The set of RS resources can include one or both of a set of SS/PBCH block indexes, each provided by ssb-Index in PUCCH-PathlossReferenceRS when a value of a corresponding pucch-PathlossReferenceRS-Id maps to a SS/PBCH block index, and a set of CSI-RS resource indexes, each provided by csi-RS-Index when a value of a corresponding pucch-PathlossReferenceRS-Id maps to a CSI-RS resource index. The UE identifies a RS resource in the set of RS resources to correspond either to a SS/PBCH block index or to a CSI-RS resource index as provided by pucch-PathlossReferenceRS-Id in PUCCH-PathlossReferenceRS
   If the UE is provided pathlossReferenceRSs and PUCCH-SpatialRelationInfo, the UE obtains a mapping, by indexes provided by corresponding values of pucch-PathlossReferenceRS-Id, between a set of pucch-SpatialRelationInfoId values and a set of referenceSignal values provided by PUCCH-PathlossReferenceRS. If the UE is provided more than one values for pucch-SpatialRelationInfoId and the UE receives an activation command [11, TS 38.321] indicating a value of pucch-SpatialRelationInfoId, the UE determines the referenceSignal value in PUCCH-PathlossReferenceRS through the link to a corresponding pucch-PathlossReferenceRS-Id index. The UE applies the activation command in the first slot that is after slot k+3·Nₛₗₒₜ^{subframe,μ} where k is the slot where the UE would transmit a PUCCH with HARQ-ACK information for the PDSCH providing the activation command and μ is the SCS configuration for the PUCCH
   If PUCCH-SpatialRelationInfo includes servingCellId indicating a serving cell, the UE receives the RS for resource index q_{d} on the active DL BWP of the serving cell
   If the UE is provided pathlossReferenceRSs and is not provided PUCCH-SpatialRelationInfo, the UE obtains the referenceSignal value in PUCCH-PathlossReferenceRS from the pucch-PathlossReferenceRS-Id with index 0 in PUCCH-PathlossReferenceRS where the RS resource is either on the primary cell or, if provided, on a serving cell indicated by a value of pathlossReferenceLinking
   If the UE
      is not provided pathlossReferenceRSs, and
      is not provided PUCCH-SpatialRelationInfo, and
      is provided enableDefaultBeamPL-ForPUCCH, and
      is not provided coresetPoolIndex value of 1 for any CORESET, or is provided coresetPoolIndex value of 1 for all CORESETs, in ControlResourceSet and no codepoint of a TCI field, if any, in a DCI format of any search space set maps to two TCI states [5, TS 38.212]
      the UE determines a RS resource index q_{d} providing a periodic RS resource configured with qcl-Type set to ‘typeD’ in the TCI state or the QCL assumption of a CORESET with the lowest index in the active DL BWP of the primary cell. For a PUCCH transmission over multiple slots, a same q_{d} applies to the PUCCH transmission in each of the multiple slots.
The parameter Δ_{F_PUCCH}(F) is a value of deltaF-PUCCH-f0 for PUCCH format 0, deltaF-PUCCH-f1 for PUCCH format 1, deltaF-PUCCH-f2 for PUCCH format 2, deltaF-PUCCH-f3 for PUCCH format 3, and deltaF-PUCCH-f4 for PUCCH format 4, if provided; otherwise Δ_{F_PUCCH}(F)=0.
Δ_{TF,b,f,c}(i) is a PUCCH transmission power adjustment component on active UL BWP b of carrier f of primary cell c
   For a PUCCH transmission using PUCCH format 0 or PUCCH format 1,

$${Δ}_{TF , b , f , c} ( i ) = 10 {log}_{10} ( \frac{{N}_{ref}^{PUCCH}}{{N}_{symb}^{PUCCH} ( i )} ) + {Δ}_{UCI} ( i )$$

where
   N_{symb}^{PUCCH}(i) is a number of PUCCH format 0 symbols or PUCCH format 1 symbols for the PUCCH transmission as described in clause 9.2.
   N_{ref}^{PUCCH}=2 for PUCCH format 0
   N_{ref}^{PUCCH}=N_{symb}^{slot} for PUCCH format 1
   Δ_{UCI}(i)=0 for PUCCH format 0
   A_{UCI}(i)=10 log₁₀(O_{UCI}(i)) for PUCCH format 1, where O_{UCI}(i) is a number of UCI bits in PUCCH transmission occasion i
For a PUCCH transmission using PUCCH format 2 or PUCCH format 3 or PUCCH format 4 and for a number of UCI bits smaller than or equal to 11, Δ_{TF,b,f,c}(i)=10 log₁₀(K₁·(n_{HARQ-ACK}(i)+O_{SR}(i)+O_{CSI}(i))/N_{RE}(i)), where
   K₁=6
   n_{HARQ-ACK}(i) is a number of HARQ-ACK information bits that the UE determines as described in clause 9.1.2.1 for Type-1 HARQ-ACK codebook and as described in clause 9.1.3.1 or 9.1.3.3 for Type-2 HARQ-ACK codebook. n_{HARQ-ACK}(i) is the same as O_{ACK}(i) as described in clause 9.1.4 for Type-3 HARQ-ACK codebook. If the UE is not provided any of pdsch-HARQ-ACK-Codebook, pdsch-HARQ-ACK-Codebook-r16, or pdsch-HARQ-ACK-OneShotFeedback, n_{HARQ-ACK}(i)=1 if the UE includes a HARQ-ACK information bit in the PUCCH transmission; otherwise, n_{HARQ-ACK}(i)=0
   O_{SR}(i) is a number of SR information bits that the UE determines as described in clause 9.2.5.1
   O_{CSI}(i) is a number of CSI information bits that the UE determines as described in clause 9.2.5.2
   N_{RE}(i) is a number of resource elements determined as N_{RE}(i)=M_{RB,b,f,c}^{PUCCH}(i)·N_{sc,ctrl}^{RB}(i)·N_{symb,UCI,b,f,c}^{PUCCH}(i), where N_{sc,ctrl}^{RB}(i) is a number of subcarriers per resource block excluding subcarriers used for DM-RS transmission, and N_{symb,UCI,b,f,c}^{PUCCH}(i) is a number of symbols excluding symbols used for DM-RS transmission, as defined in clause 9.2.5.2, for PUCCH transmission occasion i on active UL BWP b of carrier f of primary cell c
For a PUCCH transmission using PUCCH format 2 or PUCCH format 3 or PUCCH format 4 and for a number of UCI bits larger than 11, Δ_{TF,b,f,c}(i)=10 log₁₀(2^{K}^{₂}^{·BPRE(i)}−1), where
   K₂=2.4

$$BPRE ( i ) = ( {O}_{ACK} ( i ) + {O}_{SR} ( i ) + {O}_{CSI} ( i ) + {O}_{CRC} ( i ) ) / {N}_{RE} ( i )$$

O_{ACK}(i) is a number of HARQ-ACK information bits that the UE determines as described in clause 9.1.2.1 for Type-1 HARQ-ACK codebook and as described in clause 9.1.3.1 or 9.1.3.3 for Type-2 HARQ-ACK codebook, or as described in clause 9.1.4 for Type-3 HARQ-ACK codebook. If the UE is not provided any of pdsch-HARQ-ACK-Codebook, pdsch-HARQ-ACK-Codebook-r16, or pdsch-HARQ-ACK-OneShotFeedback, O_{ACK}=1 if the UE includes a HARQ-ACK information bit in the PUCCH transmission; otherwise, O_{ACK}=0
O_{SR} (i) is a number of SR information bits that the UE determines as described in clause 9.2.5.1
O_{CSI}(i) is a number of CSI information bits that the UE determines as described in clause 9.2.5.2
O_{CRC}(i) is a number of CRC bits that the UE determines as described in clause 9.2
N_{RE}(i) is a number of resource elements that the UE determines as N_{RE}(i)=M_{RB,b,f,c}^{PUCCH}(i)·N_{sc,ctrl}^{RB}(i)·N_{symb,UCI,b,f,c}^{PUCCH}(i), where N_{sc,ctrl}^{RB}(i) is a number of subcarriers per resource block excluding subcarriers used for DM-RS transmission, and N_{symb,UCI,b,f,c}^{PUCCH}(i) is a number of symbols excluding symbols used for DM-RS transmission, as defined in clause 9.2.5.2, for PUCCH transmission occasion i on active UL BWP b of carrier f of primary cell c.
For the PUCCH power control adjustment state g_{b,f,c}(i,l) for active UL BWP b of carrier f of primary cell c and PUCCH transmission occasion i
   δ_{PUCCH,b,f,c}(i,l) is a TPC command value included in a DCI format scheduling a PDSCH reception for active UL BWP b of carrier f of the primary cell c that the UE detects for PUCCH transmission occasion i, or is jointly coded with other TPC commands in a DCI format 2_2 with CRC scrambled by TPC-PUCCH-RNTI [5, TS 38.212], as described in clause 11.3
   l∈{0, 1} if the UE is provided twoPUCCH-PC-AdjustmentStates and PUCCH-SpatialRelationInfo and l=0 if the UE is not provided twoPUCCH-PC-AdjustmentStates or PUCCH-SpatialRelationInfo
   If the UE obtains a TPC command value from a DCI format scheduling a PDSCH reception and if the UE is provided PUCCH-SpatialRelationInfo, the UE obtains a mapping, by an index provided by p0-PUCCH-Id, between a set of pucch-SpatialRelationInfoId values and a set of values for closedLoopIndex that provide the l value(s). If the UE receives an activation command indicating a value of pucch-SpatialRelationInfoId, the UE determines the value closedLoopIndex that provides the value of l through the link to a corresponding p0-PUCCH-Id index
   If the UE obtains one TPC command from a DCI format 2_2 with CRC scrambled by a TPC-PUCCH-RNTI, the l value is provided by the closed loop indicator field in DCI format 2_2

$${g}_{b , f , c} ( i , l ) = {g}_{b , f , c} ( i - {i}_{0} , l ) + {PUCCH , b , f , c}_{} ( m , l )$$

is the current PUCCH power control adjustment state l for active UL BWP b of carrier f of primary cell c and PUCCH transmission occasion i, where
   The δ_{PUCCH,b,f,c} values are given in Table 7.1.2-1

$${PUCCH , b , f , c}_{} ( m , l )$$

is a sum of TPC command values in a set Cᵢ of TPC command values with cardinality [symbol] (Cᵢ) that the UE receives between K_{PUCCH}(i−i₀)−1 symbols before PUCCH transmission occasion i−i₀ and K_{PUCCH}(i) symbols before PUCCH transmission occasion i on active UL BWP b of carrier f of primary cell c for PUCCH power control adjustment state, where i₀>0 is the smallest integer for which K_{PUCCH}(i−i₀) symbols before PUCCH transmission occasion i−i₀ is earlier than K_{PUCCH}(i) symbols before PUCCH transmission occasion i
If the PUCCH transmission is in response to a detection by the UE of a DCI format, K_{PUCCH}(i) is a number of symbols for active UL BWP b of carrier f of primary cell c after a last symbol of a corresponding PDCCH reception and before a first symbol of the PUCCH transmission
If the PUCCH transmission is not in response to a detection by the UE of a DCI format, K_{PUCCH}( ) is a number of K_{PUCCH, min} symbols equal to the product of a number of symbols per slot, N_{symb}^{slot}, and the minimum of the values provided by k2 in PUSCH-ConfigCommon for active UL BWP b of carrier f of primary cell c
If the UE has reached maximum power for active UL BWP b of carrier f of primary cell c at PUCCH transmission occasion i−i₀ and

$${PUCCH , b , f , c}_{} ( m , l ) \geq 0 ,$$

then

$${g}_{b , f , c} ( i , l ) = {g}_{b , f , c} ( i - {i}_{0} , l )$$

If UE has reached minimum power for active UL BWP b of carrier f of primary cell c at PUCCH transmission occasion i−i₀ and

$${PUCCH , b , f , c}_{} ( m , l ) \leq 0 ,$$

then

$${g}_{b , f , c} ( i , l ) = {g}_{b , f , c} ( i - {i}_{0} , l )$$

If a configuration of a P_{O_PUCCH,b,f,c}(qᵤ) value for a corresponding PUCCH power control adjustment state l for active UL BWP b of carrier f of primary cell c is provided by higher layers,
   g_{b,f,c}(k,l)=0, k=0, 1, . . . , i
   If the UE is provided PUCCH-SpatialRelationInfo, the UE determines the value of l from the value of qᵤ based on a pucch-SpatialRelationInfoId value associated with the p0-PUCCH-Id value corresponding to qᵤ and with the closedLoopIndex value corresponding to l; otherwise, l=0
Else,
   g_{b,f,c}(0,l)=ΔP_{rampup,b,f,c}+δ_{b,f,c}, where l=0, and δ_{b,f,c} is
   the TPC command value indicated in a random access response grant corresponding to a PRACH transmission according to Type-1 random access procedure, or in a random access response grant corresponding to MsgA transmissions according to Type-2 random access procedure with RAR message(s) for fallbackRAR, or
   the TPC command value indicated in a successRAR corresponding to MsgA transmissions for Type-2 random access procedure, or
   the TPC command value in a DCI format with CRC scrambled by C-RNTI or MCS-C-RNTI that the UE detects in a first PDCCH reception in a search space set provided by recoverySearchSpaceId if the PUCCH transmission is a first PUCCH transmission after 28 symbols from a last symbol of the first PDCCH reception,
   and, if the UE transmits PUCCH on active UL BWP b of carrier f of primary cell c,

$$Δ {P}_{rampup , b , f , c} = min [ \begin{matrix}max ( \begin{matrix}0 , \\ {P}_{CMAX , f , c} - ( {P}_{O \_ PUCCH , b , f , c} + {PL}_{b , f , c} ( {q}_{d} ) + {Δ}_{F \_ PUCCH} ( F ) + {Δ}_{TF , b , f , c} + {δ}_{b , f , c}\end{matrix} ) \\ Δ {P}_{rampuprequested , b , f , c}\end{matrix} ] ;$$

otherwise,

$$Δ {P}_{rampup , b , f , c} = min [ \begin{matrix}max ( \begin{matrix}0 , \\ {P}_{CMAX , f , c} - ( {P}_{O \_ PUCCH , b , f , c} + {PL}_{b , f , c} ( {q}_{d} ) )\end{matrix} ) , \\ Δ {P}_{rampuprequested , b , f , c}\end{matrix} ]$$

$$where$$

$$Δ {P}_{rampuprequested , b , f , c}$$

provided by higher layers and corresponds to the total power ramp-up requested by higher layers from the first to the last preamble for active UL BWP b of carrier f of primary cell c, and Δ_{F_PUCCH}(F) corresponds to PUCCH format 0 or PUCCH format 1.

TABLE 7.2.1-1
Mapping of TPC Command Field in a DCI format
to accumulated δ_{PUCCH, b, f, c} values:

| TPC Command | Accumulated |
|---|---|
| Field | δ_{PUCCH, b, f, c} [dB] |
| 0 | −1 |
| 1 | 0 |
| 2 | 1 |
| 3 | 3 |

### HARQ Feedback Generation and Transmission

The procedure for receiving downlink transmission is that the UE first monitors and decodes a PDDCH in slot n which points to a DL data scheduled in slot n+K₀ slots (K₀ is larger than or equal to 0). The UE then decodes the data in the corresponding PDSCH. Finally based on the outcome of the decoding the UE sends an acknowledgement of the correct decoding (ACK) or a negative acknowledgement (NACK) to the gNB at time slot n+K₀+K₁ (in case of slot aggregation n+K₀ would be replaced by the slot where PDSCH ends). Both of K₀ and K₁ are indicated in the DCI. The resources for sending the acknowledgement are indicated by PUCCH resource indicator (PRI) field in the DCI which points to one of PUCCH resources that are configured by higher layers.

Depending on DL/UL slot configurations, or whether carrier aggregation, or per code-block group (CBG) transmission used in the DL, the feedback for several PDSCHs may need to be multiplexed in one feedback. This is done by constructing HARQ-ACK codebooks. In NR, the UE can be configured to multiplex the A/N bits using a semi-static codebook or a dynamic codebook.

FIG. 3 illustrates the timeline in a simple scenario with two PDSCHs and one feedback. In this example there is in total four PUCCH resources configured, and the PRI indicates PUCCH 2 to be used for HARQ feedback. The following explains how PUCCH 2 is selected from four PUCCH resources based on the procedure in Rel-15.

In NR Rel-15, a UE can be configured with maximum four PUCCH resource sets for transmission of HARQ-ACK information. Each set is associated with a range of UCI payload bits including HARQ-ACK bits. The first set is always associated to 1 or 2 HARQ-ACK bits and hence includes only PUCCH format 0 or 1 or both. The range of payload values (minimum of maximum values) for other sets, if configured, is provided by configuration except the maximum value for the last set where a default value is used, and the minimum value of the second set being 3. The first set can include maximum 32 PUCCH resources of PUCCH format 0 or 1. Other sets can include maximum 8 bits of format 2, or 3, or 4.

As described previously, the UE determines a slot for transmission of HARQ-ACK bits in a PUCCH corresponding to PDSCHs scheduled or activated by DCI via K₁ value provided by configuration or a field in the corresponding DCI. The UE forms a codebook from the HARQ-ACK bits with associated PUCCH in a same slot via corresponding K₁ values.

The UE determines a PUCCH resource set that the size of the codebook is within the corresponding range of payload values associated to that set.

The UE determines a PUCCH resource in that set if the set is configured with maximum 8 PUCCH resources, by a field in the last DCI associated to the corresponding PDSCHs. If the set is the first set and is configured with more than 8 resources, a PUCCH resource in that set is determined by a field in the last DCI associated to the corresponding PDSCHs and implicit rules based on the CCE.

A PUCCH resource for HARQ-ACK transmission can overlap in time with other PUCCH resources for CSI and/or SR transmissions as well as PUSCH transmissions in a slot. In case of overlapping PUCCH and/or PUSCH resources, first the UE resolves overlapping between PUCCH resources, if any, by determining a PUCCH resource carrying the total UCI (including HARQ-ACK bits) such that the UCI multiplexing timeline requirements are met. There might be partial or completely dropping of CSI bits, if any, to multiplex the UCI in the determined PUCCH resource. Then, the UE resolves overlapping between PUCCH and PUSCH resources, if any, by multiplexing the UCI on the PUSCH resource if the timeline requirements for UCI multiplexing is met.

### Semi-Static (Type-1) HARQ Codebook

Type 1 or semi-static codebook consists of a bit sequence where each element contains the A/N bit from a possible allocation in a certain slot, carrier, or transport block (TB). When the UE is configured with CBG and/or time-domain resource allocation (TDRA) table with multiple entries, multiple bits are generated per slot and TB (see below). It is important to note that the codebook is derived regardless of the actual PDSCH scheduling. The size and format of the semi-static codebook is preconfigured based on the mentioned parameters. The drawback of semi-static HARQ ACK codebook is that the size is fixed, and regardless of whether there is a transmission or not a bit is reserved in the feedback matrix.

On the case when a UE has a TDRA table with multiple time-domain resource allocation entries configured: The table is pruned (i.e., entries are removed based on a specified algorithm) to derive a TDRA table that only contains non-overlapping time-domain allocations. One bit is then reserved in the HARQ CB for each non-overlapping entry (assuming a UE is capable of supporting reception of multiple PDSCH in a slot).

### Dynamic (Type-2) HARQ Codebook

In type 2 or dynamic HARQ codebook, an A/N bit is present in a codebook only if there is a corresponding transmission scheduled. To avoid any confusion between the gNB and the UE, on the number of PDSCHs that the UE has to send a feedback for, a counter downlink assignment indicator (DAI) field exists in DL assignment, which denotes accumulative number of {serving cell, PDCCH occasion} pairs in which a PDSCH is scheduled to a UE up to the current PDCCH. In addition to that, there is another field called total DAI, which when present shows the total number of {serving cell, PDCCH occasion} up to (and including) all PDCCHs of the current PDCCH monitoring occasion. The timing for sending HARQ feedback is determined based on both PDSCH transmission slot with reference to PDCCH slot (K₀) and the PUCCH slot that contains HARQ feedback (K₁).

### Enhanced Dynamic (Type-2) HARQ Codebook

In Rel-16, enhanced dynamic codebook or enhanced Type-2 codebook based on Type 2 codebook is introduced to enable retransmission of the HARQ feedback corresponding to the used HARQ processes. If, for any reason, the scheduled codebook was not received, the retransmission of the feedback can be requested by the gNB. A toggle bit, new feedback indicator (NFI), is added in the DCI to indicate whether the HARQ-ACK feedback from the UE was received by the gNB or not. If toggled, the UE assumes that the reported feedback was correctly received. Otherwise, if the gNB fails to receive the scheduled PUCCH the UE is expected to retransmit the feedback. In the latter case, the DAI (C/T-DAI) is not reset, instead the DAI are accumulated within a PDSCH group until NFI for the PDSCH group is toggled.

As the triggering of additional HARQ feedback reporting occurs with ambiguous timing relation to the associated PDSCHs, PDSCH grouping is introduced. PDSCH group is defined as the PDSCH(s) for which the HARQ-ACK information is originally indicated to be carried in a same PUCCH. PDSCH grouping allows the gNB to explicitly indicate which codebook is missing. The group index is explicitly signaled in the scheduling DCI. If enhanced dynamic codebook is configured, two PDSCH groups are supported. Together with the group ID, the gNB signals a request group ID which is a 1-bit field. By referring to the group Id (ID), request ID (RI), and the value of the NFI field in the DCI, the UE can figure out if the next feedback occasion should include only initial transmission or also retransmission of feedback corresponding to PDSCH(s) associated with the indicated group.

Similar to NR, the DAI value is also included in the UL grant scheduling PUSCH. As an additional functionality, the gNB can indicate the DAI value for each group separately in the UL grant to resolve any possible ambiguity at the UE side.

There currently exist certain challenge(s). In NR R16 UCI of different priority index cannot be multiplexed on same PUCCH. For NR R17 there is ongoing discussions to support multiplexing of UCI with different priority index. The current PUCCH power control does not account that UCI can consist of UCI with different priority index which can lead to that the PUCCH power is not properly adjusted.

Certain aspects of the disclosure and their embodiments may provide solutions to these or other challenges. Some embodiments of the current disclosure, a UE determines PUCCH power adjustment with respect to PUCCH format and/or transport format (TF) based on one or more out of: UCI consists of UCI with same priority index or different priority indices; number of high-priority and/or low-priority UCI bits; minimum of high-priority and low-priority UCI bits. In some embodiments, the UE determines PUCCH power adjustment with respect to PUCCH format and/or transport format (TF) based on one or more out of: UCI consists UCI with same priority index or different priority index; number of HP and/or LP; minimum of HP and LP bits.

Certain embodiments may provide one or more of the following technical advantage(s). In some embodiments, properly adjusting PUCCH power is enabled when UCI consists of UCI with different priority index. UCI with low priority index will be referred to as LP UCI and UCI with high priority index will be referred to as HP UCI.

### SUMMARY

Systems and methods for enhanced Physical Uplink Control Channel (PUCCH) power control when missing Uplink Control Information (UCI) of different priorities are provided. In some embodiments, a method performed by a User Equipment (UE) for determining a power adjustment includes determining a PUCCH power adjustment with respect to a PUCCH format and/or Transport Format (TF); wherein determining the PUCCH power adjustment is based on one or more out of: a UCI consists of UCI with same priority index or different priority indices; a number of high-priority and/or low-priority UCI bits; and a minimum of high-priority and low-priority UCI bits. In this way, PUCCH power is able to be properly adjusted when UCI consists of UCI with different priority index.

In some embodiments, determining the PUCCH power adjustment comprises: if the PUCCH includes UCI bits of high-priority and low-priority, determining the PUCCH power adjustment assuming that all UCI bits have high-priority.

In some embodiments, the UCI bits comprise HARQ-ACK information bits. In some embodiments, the high-priority UCI bits comprise priority index=1; and low-priority UCI bits comprise priority index=0.

In some embodiments, the method also includes transmitting the PUCCH according to the determined PUCCH power adjustment.

In some embodiments, the UCI bits are separately coded, or are jointly coded, before mapping to the PUCCH.

In some embodiments, the method also includes two deltaF-PUCCH-fX for PUCCH format X, where a first (or second) value is used to determine Δ_{F_PUCCH}(F) when UCI consists of UCI with different priority indices and a second (or first) value is used when UCI consists of UCI all having the same priority index.

In some embodiments, receiving the two deltaF-PUCCH-fX values for PUCCH format X comprises receiving an extended RRC IE PUCCH-PowerControl.

In some embodiments, determining the PUCCH power adjustment comprises adjusting the Δ_{TF,b,f,c}(i) term in the PUCCH power control formula. In some embodiments, the formula for calculating Δ_{TF,b,f,c}(i) is selected as a function of the number of a subset of the UCI bits, instead of the total number of UCI bits, carried by the PUCCH.

In some embodiments, the subset of the UCI bits refers to the high priority UCI bits. In some embodiments, when the UCI bits carried by the PUCCH is divided into two (or more) parts, and separate coding is applied to each part, then the subset of the UCI bits refer to the number of UCI bits in one part.

In some embodiments, when the UCI bits carried by the PUCCH is divided into two (or more) parts, and separate coding is applied to each part, then the subset of the UCI bits refer to the number of UCI bits in one part.

In some embodiments, a method performed by a network node for determining a power adjustment includes configuring a UE to determine a PUCCH power adjustment with respect to a PUCCH format and/or TF; wherein determining the PUCCH power adjustment is based on one or more out of: a UCI consists of UCI with same priority index or different priority indices; a number of high-priority and/or low-priority UCI bits; and a minimum of high-priority and low-priority UCI bits.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates the basic New Radio (NR) physical resource time-frequency grid, where a Resource Block (RB) in a 14-symbol slot;

FIG. 2 illustrates a 14-symbol slot, where the first two symbols contain control channel (PDCCH) and the rest contains data channel (PDSCH);

FIG. 3 illustrates the timeline in a simple scenario with two PDSCHs and one feedback;

FIG. 4 illustrates a method performed by a user equipment for determining a power adjustment, according to some embodiments of the present disclosure;

FIG. 5 illustrates a method performed by a network node for enabling a power adjustment, according to some embodiments of the present disclosure;

FIG. 6 shows an example of a communication system in accordance with some embodiments;

FIG. 7 shows a UE in accordance with some embodiments;

FIG. 8 shows a network node in accordance with some embodiments;

FIG. 9 is a block diagram of a host, which may be an embodiment of the host of FIG. 6, in accordance with various aspects described herein;

FIG. 10 is a block diagram illustrating a virtualization environment in which functions implemented by some embodiments may be virtualized; and

FIG. 11 shows a communication diagram of a host communicating via a network node with a UE over a partially wireless connection in accordance with some embodiments.

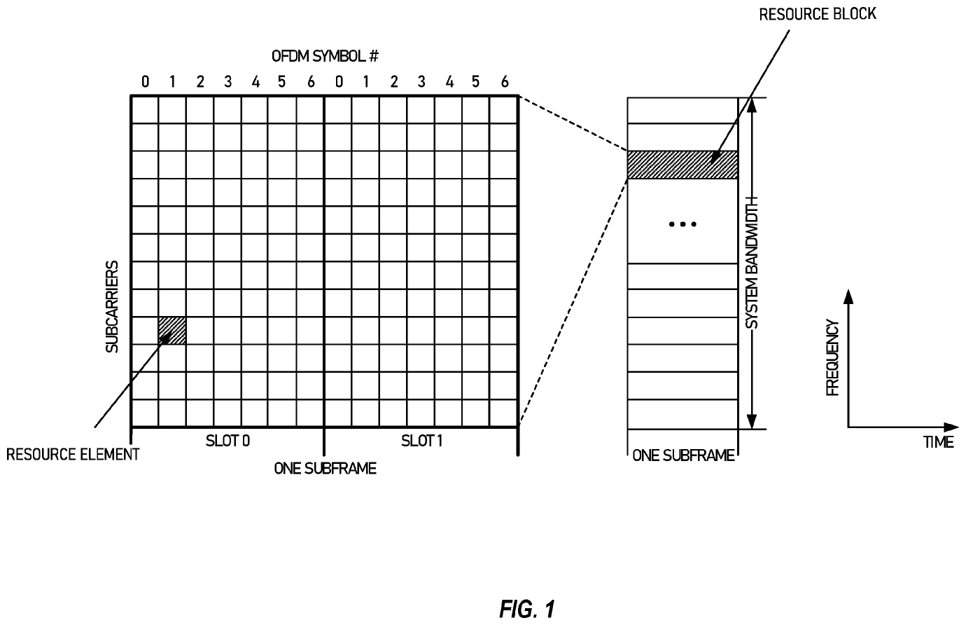

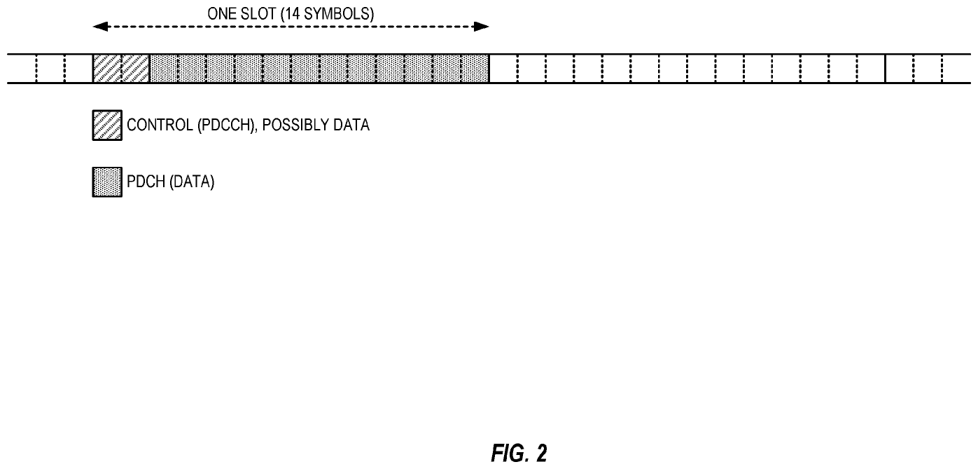

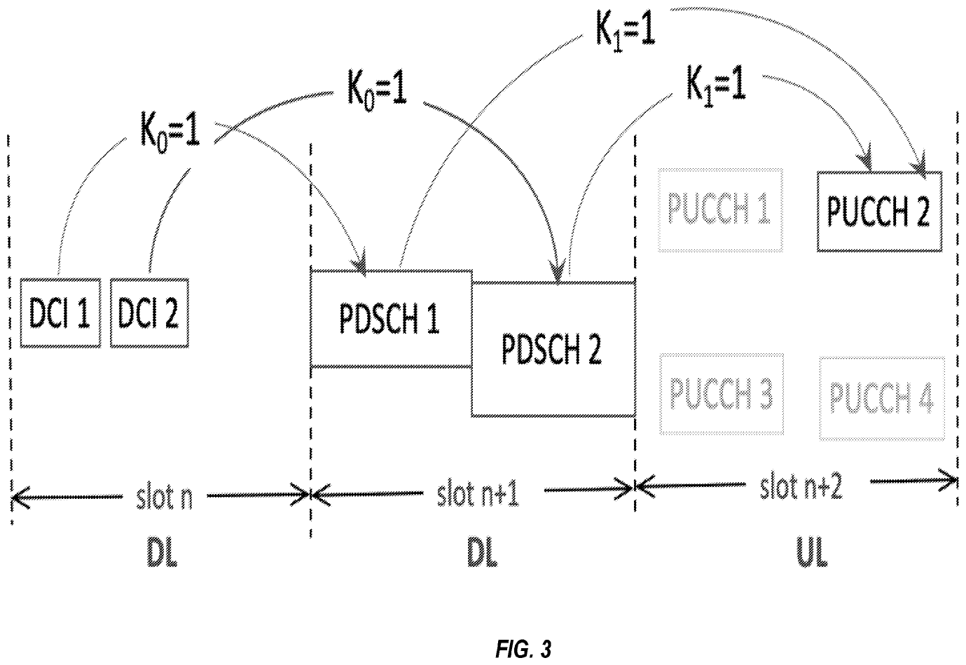

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

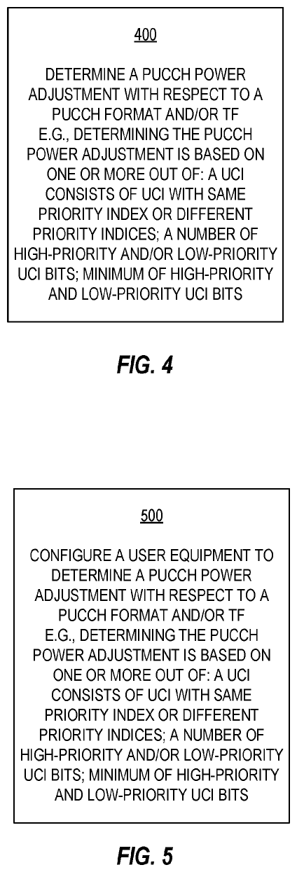

FIG. 4 illustrates a method performed by a user equipment for determining a power adjustment, the method comprising: determining (step 400) a PUCCH power adjustment with respect to a PUCCH format and/or TF. In some embodiments, determining the PUCCH power adjustment is based on one or more out of: a UCI consists of UCI with same priority index or different priority indices; a number of high-priority and/or low-priority UCI bits; minimum of high-priority and low-priority UCI bits.

FIG. 5 illustrates a method performed by a network node for enabling a power adjustment, the method comprising: configuring (step 500) a user equipment to determine a PUCCH power adjustment with respect to a PUCCH format and/or TF. In some embodiments, determining the PUCCH power adjustment is based on one or more out of: a UCI consists of UCI with same priority index or different priority indices; a number of high-priority and/or low-priority UCI bits; minimum of high-priority and low-priority UCI bits.

The methods are provided for power control determination of PUCCH transmission for active UL BWP b of carrier f in the cell c using PUCCH power control adjustment state with index l.

Unless explicitly restricted, the methods can be applied to UCI bits separately coded, or jointly coded, before mapping to the PUCCH.

### Power Adjustment as a Function of PUCCH Format

In some embodiments, the UE is provided two deltaF-PUCCH-fX for PUCCH format X, where X is the PUCCH format number, where a first (or second) value is used to determine Δ_{F_PUCCH}(F) when UCI consists of UCI with different priority indices and a second (or first) value is used when UCI consists of UCI all having the same priority index.

The UE may be provided with two deltaF-PUCCH-fX values for PUCCH format X by extending the RRC IE PUCCH-PowerControl (Section 6.3.2, 38.331, v16.5.0), with the highlighted part below:

```
-- ASN1START
-- TAG-PUCCH-POWERCONTROL-START
PUCCH-PowerControl ::= SEQUENCE {
  deltaF-PUCCH-f0 INTEGER (−16..15) OPTIONAL, -- Need R
  deltaF-PUCCH-f1 INTEGER (−16..15) OPTIONAL, -- Need R
  deltaF-PUCCH-f2 INTEGER (−16..15) OPTIONAL, -- Need R
  deltaF-PUCCH-f3 INTEGER (−16..15) OPTIONAL, -- Need R
  deltaF-PUCCH-f4 INTEGER (−16..15) OPTIONAL, -- Need R
  deltaF-PUCCH-f0-rY INTEGER (−16..15) OPTIONAL, -- Need R
  deltaF-PUCCH-f1-rY INTEGER (−16..15) OPTIONAL, -- Need R
  deltaF-PUCCH-f2-rY INTEGER (−16..15) OPTIONAL, -- Need R
  deltaF-PUCCH-f3-rY INTEGER (−16..15) OPTIONAL, -- Need R
  deltaF-PUCCH-f4-rY INTEGER (−16..15) OPTIONAL, -- Need R
  p0-Set SEQUENCE (SIZE (1..maxNrofPUCCH-P0-PerSet)) OF P0-PUCCH OPTIONAL, -- Need M
  pathlossReferenceRSs SEQUENCE (SIZE (1..maxNrofPUCCH-PathlossReferenceRSs)) OF
PUCCH-PathlossReferenceRS
  OPTIONAL, -- Need M
```

| | |
|---|---|
| twoPUCCH-PC-AdjustmentStates | ENUMERATED {twoStates} OPTIONAL, -- Need S |

```
  ...,
  [[
```

| | |
|---|---|
| pathlossReferenceRSs-v1610 | SetupRelease { PathlossReferenceRSs-v1610 } OPTIONAL |

-- Need M
]]
}

In the above, it is illustrated that the first set of deltaF-PUCCH-fX (i.e., without extension ‘-rY’) values is provided, and additionally the second set of deltaF-PUCCH-fX-rY are also provided, where x=0,1,2,3,4 refer to the PUCCH format 0, 1, 2, 3, 4, respectively.

If UE multiplexes UCI of different priority index onto a PUCCH using PUCCH format X, then Δ_{F_PUCCH}(F) is determined as deltaF-PUCCH-fX-rY. If deltaF-PUCCH-fX-rY is not provided to UE, then Δ_{F}_{_{PUCCH}}(F) is determined as deltaF-PUCCH-fX if such value is provided; otherwise UE will determine Δ_{F}_{_{PUCCH}}(F)=0.

In one embodiment, the UE is provided a deltaF-PUCCH-fX-rY as a differential RRC parameter e.g., deltaF-PUCCH-fX-differential-rY such that: deltaF-PUCCH-fX-rY=deltaF-PUCCH-fX+deltaF-PUCCH-fX-differential-rY; or deltaF-PUCCH-fX-rY=deltaF-PUCCH-fX−deltaF-PUCCH-fX-differential-rY.

In the above, the additional set of deltaF-PUCCH-fX (i.e., deltaF-PUCCH-fX-rY) values may be provided to all PUCCH-Config IE(s) or selected PUCCH-config IE(s).

If the UE is provided with one PUCCH-Config, UCIs are carried by PUCCH, under the assumption that all UCIs are of low priority (i.e., priority index=0).
a. In one alternative, no multiplexing of HP UCI and LP UCI is performed. Thus there is no need to provide the additional set of deltaF-PUCCH-fX (i.e., deltaF-PUCCH-fX-rY) values.
b. In another alternative, multiplexing of HP UCI and LP UCI is allowed, where the multiplexed UCI bits of different priority are mapped to PUCCH, even though the PUCCH was intended to carry LP UCI. In this case, the additional set of deltaF-PUCCH-fX (i.e., deltaF-PUCCH-fX-rY) values can be provided and applied, if UCI of different physical layer priority (i.e., HP UCI and LP UCI) are multiplexed and mapped to the PUCCH. For the typical case of multiplexing UCI of the same physical layer priority (e.g., priority index=0 for low priority) to PUCCH, the first set of deltaF-PUCCH-fX is applied.

If the UE is provided with two PUCCH-Config, the first PUCCH-Config is intended for low priority UCI (i.e., priority index=0), while the second PUCCH-Config is intended for high priority UCI (i.e., priority index=1).
a. In one alternative, both PUCCH-Config contain the PUCCH-PowerControl IE which have the second set (i.e., deltaF-PUCCH-fX-rY). The second set of deltaF-PUCCH-fX-rY may be assigned different values for different PUCCH-Config.
b. In another alternative, the first PUCCH-Config contain the PUCCH-PowerControl IE which does not have the second set of deltaF-PUCCH-fX values, with the understanding that only UCI bits of low priority are mapped to PUCCH resources configured by the first PUCCH-Config. The second PUCCH-Config contain the PUCCH-PowerControl IE which is extended with the second set of deltaF-PUCCH-fX values, which allows UCI bits of different priority to be mapped to PUCCH resources configured by the second PUCCH-Config.

The principle is, if UCI bits of same priority is mapped to PUCCH, then the first set of deltaF-PUCCH-fX (i.e., without extension ‘-rY’) values is used. If UCI bits of different priority is mapped to PUCCH, then the second set of deltaF-PUCCH-fX (i.e., deltaF-PUCCH-fX-rY) values is used

### Power Adjustment for TF

Another embodiment is to determine PUCCH power by adjusting the Δ_{TF,b,f,c}(i) term in the PUCCH power control formula.

The code rate used for LP UCI is in general higher than the code rate for HP UCI. Calculating the exact code rate used for HP UCI requires calculating the number of REs used for HP UCI which is complicated. The embodiments herein guarantee that the formula used when calculating the Delta_TF term uses the expression that result in an adjusted power that does not reduce the reliability for HP UCI.

### Method 2-A. Power Adjustment as a Function of TF

In this method, the formula for calculating Δ_{TF,b,f,c}(i) is selected as a function of the number of a subset of the UCI bits, instead of the total number of UCI bits, carried by the PUCCH.

In a preferred embodiment, the subset of the UCI bits refers to the high priority UCI bits. For instance, if high priority HARQ-ACK bits (HP-HARQ) and low priority HARQ-ACK (LP-HARQ) bits are multiplexed for transmission on PUCCH, Δ_{TF,b,f,c}(i) formula is selected based on the number of HP-HARQ bits, instead of the total amount of HP-HARQ and LP-HARQ ACK bits. For instance, the following can be used, which is modified from the 38.213 specification:
For a PUCCH transmission using PUCCH format 2 or PUCCH format 3 or PUCCH format 4 and for a number of high priority UCI bits smaller than or equal to 11, Δ_{TF,b,f,c}(i)=10 log₁₀(K₁·(n_{HARQ-ACK}(i)+O_{SR}(i)+O_{CSI}(i))/N_{RE}(i)), where
_{nHARQ-ACK}(i), O_{SR}(i), O_{CSI}(i) are total number of HARQ-ACK bits, SR bits, and CSI bits, and N_{RE}(i) is the number of resource elements used for transmitting all UCI bits.
   For a PUCCH transmission using PUCCH format 2 or PUCCH format 3 or PUCCH format 4 and for a number of high priority UCI bits larger than 11, Δ_{TF,b,f,c}(i)=10 log₁₀(2^{K}^{₂}^{BPRE(i)}−1), where
      . . . BPRE(i) is determined as above, where O_{ACK}(i) are total number of HARQ-ACK bits, O_{SR}(i) and O_{CSI}(i) are total number of SR bits and CSI bits, O_{CRC}(i) are the total number of CRC bits determined, and N_{RE}(i) is the number of resource elements used for transmitting all UCI bits

In another example of the above embodiment, when number of HP bits is smaller or equal to 11 bits the number of CRC bits O_{CRC}(i) potentially (if LP bits exceeds 11 bits) used for LP bits is included in calculation, i.e.,

$${Δ}_{TF , b , f , c} ( i ) = 10 {log}_{10} ( {K}_{1} \cdot ( {n}_{HARQ - ACK} ( i ) + {O}_{SR} ( i ) + {O}_{CSI} ( i ) + {O}_{CRC} ) / {N}_{RE} ( i ) ) . \qquad ( 1 )$$

In another embodiment the Δ_{TF,b,f,c}(i) formula is selected based on the minimum of HP and LP bits, i.e., if O_{HP}(i) is the number of HP bits and O_{LP} (i) is the number of LP bits then if Oₘᵢₙ(i)=min{W_{H}(i), O_{LP}(i)} is smaller than or equal to 11, Δ_{TF,b,f,c}(i)=10 log₁₀(K₁·(n_{HARQ-ACK}+O_{SR}+O_{CSI}(i))/N_{RE}(i)), where n_{HARQ-ACK}(i), O_{SR}(i), O_{CSI}(i) are total number of HARQ-ACK bits, SR bits, and CSI bits, and N_{RE}(i) is the number of resource elements used for transmitting all UCI bits, and if Oₘᵢₙ(i)=min{O_{HP}(i), O_{LP}(i)} is larger than 11, Δ_{TF,b,f,c}(i)=10 log₁₀(2^{K}^{₂}^{·BPRE(i)}−1), where BPRE(i) is determined as above, where O_{ACK}(i) are total number of HARQ-ACK bits, O_{SR}(i) and O_{CSI}(i) are total number of SR bits and CSI bits, O_{CRC}(i) are the total number of CRC bits determined, and N_{RE}(i) is the number of resource elements used for transmitting all UCI bits

That is, the selection of formula Δ_{TF,b,f,c}(i) is based on the minimum Oₘᵢₙ(i)=min{O_{HP}(i), O_{LP}(i)} of HP and LP bits, but formula is applied for sum of HP and LP bits. In some examples of this embodiment the number of CRC bits O_{CRC}(i) potentially used for LP bits is included in the formula, i.e., as formula (1) above, when Oₘᵢₙ(i)=min{O_{HP}(i), O_{LP}(i)} is smaller than or equal to 11.

In one version of the above embodiment, Δ_{TF,b,f,c}(i)=10 log₁₀(K₁(O_{HP}(i)+O_{LP}(i))/N_{RE}(i)) if Oₘᵢₙ(i) is less than 11, and Δ_{TF,b,f,c}(i)=10 log₁₀(2^{K}^{₂}^{BPRE(i)}−1), where

$$BPRE ( i ) = ( ( {O}_{HP} ( i ) + {O}_{LP} ( i ) + {O}_{HP , CRC} ( i ) + {O}_{LP , CRC} ( i ) ) / {N}_{RE} ( i ) ) ,$$

Where O_{HP,CRC}(i) and O_{LP,CRC}(i) are the number of CRC bits used for encoding HP and LP UCI bits respectively.

In another embodiment, when the UCI bits carried by the PUCCH is divided into two (or more) parts, and separate coding is applied to each part, then the subset of the UCI bits refer to the number of UCI bits in one part (e.g., part1), i.e., UCI bits in other parts (e.g., part2) are excluded. The UCI part1 may contain a mixture of high priority and low priority bits. For example, if the entire set of UCI bits to be carried by PUCCH include: HP HARQ-ACK bits, LP HARQ-ACK bits, CSI-part1, CSI-part2, then the UCI bits are divided into two parts and separately encoded (e.g., RM code, Polar code). For instance, the two-part UCI can be allocated as follows:
UCI-part1={HP HARQ-ACK bits, LP HARQ-ACK bits};
UCI-part2={CSI-part1, CSI-part2}

The number of UCI-part1 bits is then used to select the formula for Δ_{TF,b,f,c}(i), e.g., if the number of UCI-part1 bits is <=11 bits or >11 bits.

### Method 2-B. Power Adjustment Using a Scaling Factor

In this method, a new parameter is introduced to scale the code rate (or similarly, BPRE) in Δ_{TF,b,f,c}(i) calculation. The new parameter is denoted as D_{HPLP} in the discussion below. The scaling factor D_{HPLP} can be set as follows:
If the UCI carried by PUCCH is of the same priority, then D_{HPLP}=1.
Otherwise: D_{HPLP} is set to a scaling factor value. The scaling factor value can be predefined. E.g., D_{HPLP}=1.5. Alternatively, the scaling factor value can be semi-statically configured by RRC signalling. The scaling factor value can be configured as part of PUCCH-PowerControl IE or PUCCH-Config IE.

This method can be specified using exemplary texts below, which is modified from 38.213.

For a PUCCH transmission using PUCCH format 2 or PUCCH format 3 or PUCCH format 4 and for a number of UCI bits smaller than or equal to 11, Δ_{TF,b,f,c}(i)=10 log₁₀(K₁·(n_{HARQ-ACK} (i)+O_{SR}(i)+O_{CSI}(i))/N_{RE}(i)), where:

$${K}_{1} = 6 \times {D}_{HPLP} ;$$

For a PUCCH transmission using PUCCH format 2 or PUCCH format 3 or PUCCH format 4 and for a number of UCI bits larger than 11, Δ_{TF,b,f,c}(i)=10 log₁₀(2^{K}^{₂}^{·BPRE(i)}−1), where

$${K}_{2} = 2.4 \times {D}_{HPLP} ;$$

$$BPRE ( i ) = ( {O}_{ACK} ( i ) + {O}_{SR} ( i ) + {O}_{CSI} ( i ) + {O}_{CRC} ( i ) ) / {N}_{RE} ( i )$$

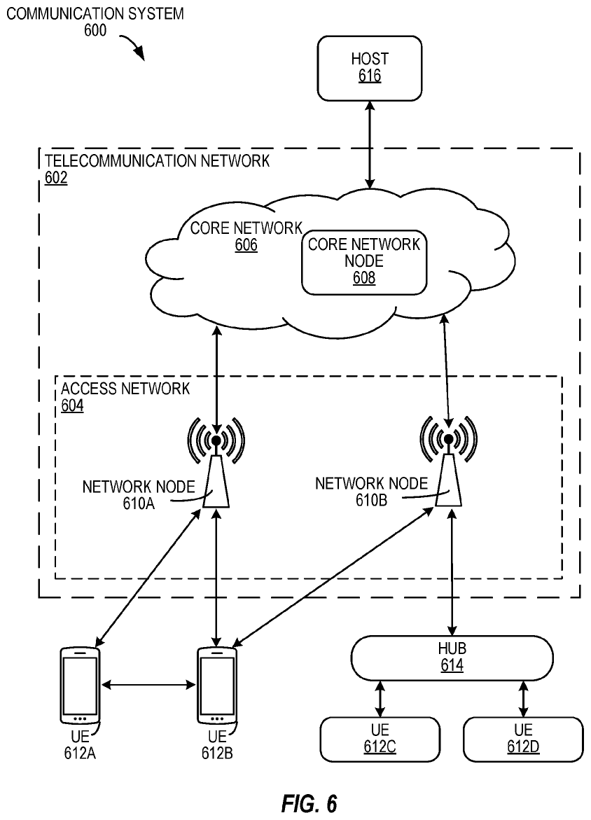

FIG. 6 shows an example of a communication system 600 in accordance with some embodiments.

In the example, the communication system 600 includes a telecommunication network 602 that includes an access network 604, such as a Radio Access Network (RAN), and a core network 606, which includes one or more core network nodes 608. The access network 604 includes one or more access network nodes, such as network nodes 610A and 610B (one or more of which may be generally referred to as network nodes 610), or any other similar Third Generation Partnership Project (3GPP) access node or non-3GPP Access Point (AP). The network nodes 610 facilitate direct or indirect connection of User Equipment (UE), such as by connecting UEs 612A, 612B, 612C, and 612D (one or more of which may be generally referred to as UEs 612) to the core network 606 over one or more wireless connections.

Example wireless communications over a wireless connection include transmitting and/or receiving wireless signals using electromagnetic waves, radio waves, infrared waves, and/or other types of signals suitable for conveying information without the use of wires, cables, or other material conductors. Moreover, in different embodiments, the communication system 600 may include any number of wired or wireless networks, network nodes, UEs, and/or any other components or systems that may facilitate or participate in the communication of data and/or signals whether via wired or wireless connections. The communication system 600 may include and/or interface with any type of communication, telecommunication, data, cellular, radio network, and/or other similar type of system.

The UEs 612 may be any of a wide variety of communication devices, including wireless devices arranged, configured, and/or operable to communicate wirelessly with the network nodes 610 and other communication devices. Similarly, the network nodes 610 are arranged, capable, configured, and/or operable to communicate directly or indirectly with the UEs 612 and/or with other network nodes or equipment in the telecommunication network 602 to enable and/or provide network access, such as wireless network access, and/or to perform other functions, such as administration in the telecommunication network 602.

In the depicted example, the core network 606 connects the network nodes 610 to one or more hosts, such as host 616. These connections may be direct or indirect via one or more intermediary networks or devices. In other examples, network nodes may be directly coupled to hosts. The core network 606 includes one more core network nodes (e.g., core network node 608) that are structured with hardware and software components. Features of these components may be substantially similar to those described with respect to the UEs, network nodes, and/or hosts, such that the descriptions thereof are generally applicable to the corresponding components of the core network node 608. Example core network nodes include functions of one or more of a Mobile Switching Center (MSC), Mobility Management Entity (MME), Home Subscriber Server (HSS), Access and Mobility Management Function (AMF), Session Management Function (SMF), Authentication Server Function (AUSF), Subscription Identifier De-Concealing Function (SIDF), Unified Data Management (UDM), Security Edge Protection Proxy (SEPP), Network Exposure Function (NEF), and/or a User Plane Function (UPF).

The host 616 may be under the ownership or control of a service provider other than an operator or provider of the access network 604 and/or the telecommunication network 602, and may be operated by the service provider or on behalf of the service provider. The host 616 may host a variety of applications to provide one or more service. Examples of such applications include live and pre-recorded audio/video content, data collection services such as retrieving and compiling data on various ambient conditions detected by a plurality of UEs, analytics functionality, social media, functions for controlling or otherwise interacting with remote devices, functions for an alarm and surveillance center, or any other such function performed by a server.

As a whole, the communication system 600 of FIG. 6 enables connectivity between the UEs, network nodes, and hosts. In that sense, the communication system 600 may be configured to operate according to predefined rules or procedures, such as specific standards that include, but are not limited to: Global System for Mobile Communications (GSM); Universal Mobile Telecommunications System (UMTS); Long Term Evolution (LTE), and/or other suitable Second, Third, Fourth, or Fifth Generation (2G, 3G, 4G, or 5G) standards, or any applicable future generation standard (e.g., Sixth Generation (6G)); Wireless Local Area Network (WLAN) standards, such as the Institute of Electrical and Electronics Engineers (IEEE) 802.11 standards (WiFi); and/or any other appropriate wireless communication standard, such as the Worldwide Interoperability for Microwave Access (WiMax), Bluetooth, Z-Wave, Near Field Communication (NFC) ZigBee, LiFi, and/or any Low Power Wide Area Network (LPWAN) standards such as LoRa and Sigfox.

In some examples, the telecommunication network 602 is a cellular network that implements 3GPP standardized features. Accordingly, the telecommunication network 602 may support network slicing to provide different logical networks to different devices that are connected to the telecommunication network 602. For example, the telecommunication network 602 may provide Ultra Reliable Low Latency Communication (URLLC) services to some UEs, while providing enhanced Mobile Broadband (eMBB) services to other UEs, and/or massive Machine Type Communication (mMTC)/massive Internet of Things (IoT) services to yet further UEs.

In some examples, the UEs 612 are configured to transmit and/or receive information without direct human interaction. For instance, a UE may be designed to transmit information to the access network 604 on a predetermined schedule, when triggered by an internal or external event, or in response to requests from the access network 604. Additionally, a UE may be configured for operating in single- or multi-Radio Access Technology (RAT) or multi-standard mode. For example, a UE may operate with any one or combination of WiFi, New Radio (NR), and LTE, i.e., be configured for Multi-Radio Dual Connectivity (MR-DC), such as Evolved UMTS Terrestrial RAN (E-UTRAN) NR-Dual Connectivity (EN-DC).

In the example, a hub 614 communicates with the access network 604 to facilitate indirect communication between one or more UEs (e.g., UE 612C and/or 612D) and network nodes (e.g., network node 610B). In some examples, the hub 614 may be a controller, router, content source and analytics, or any of the other communication devices described herein regarding UEs. For example, the hub 614 may be a broadband router enabling access to the core network 606 for the UEs. As another example, the hub 614 may be a controller that sends commands or instructions to one or more actuators in the UEs. Commands or instructions may be received from the UEs, network nodes 610, or by executable code, script, process, or other instructions in the hub 614. As another example, the hub 614 may be a data collector that acts as temporary storage for UE data and, in some embodiments, may perform analysis or other processing of the data. As another example, the hub 614 may be a content source. For example, for a UE that is a Virtual Reality (VR) headset, display, loudspeaker or other media delivery device, the hub 614 may retrieve VR assets, video, audio, or other media or data related to sensory information via a network node, which the hub 614 then provides to the UE either directly, after performing local processing, and/or after adding additional local content. In still another example, the hub 614 acts as a proxy server or orchestrator for the UEs, in particular in if one or more of the UEs are low energy IoT devices.

The hub 614 may have a constant/persistent or intermittent connection to the network node 610B. The hub 614 may also allow for a different communication scheme and/or schedule between the hub 614 and UEs (e.g., UE 612C and/or 612D), and between the hub 614 and the core network 606. In other examples, the hub 614 is connected to the core network 606 and/or one or more UEs via a wired connection. Moreover, the hub 614 may be configured to connect to a Machine-to-Machine (M2M) service provider over the access network 604 and/or to another UE over a direct connection. In some scenarios, UEs may establish a wireless connection with the network nodes 610 while still connected via the hub 614 via a wired or wireless connection. In some embodiments, the hub 614 may be a dedicated hub—that is, a hub whose primary function is to route communications to/from the UEs from/to the network node 610B. In other embodiments, the hub 614 may be a non-dedicated hub—that is, a device which is capable of operating to route communications between the UEs and the network node 610B, but which is additionally capable of operating as a communication start and/or end point for certain data channels.

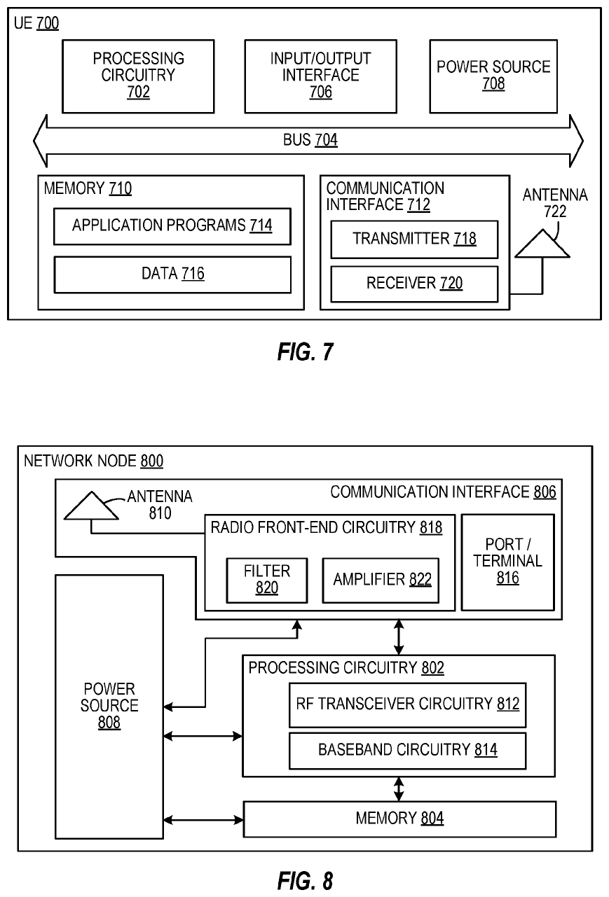

FIG. 7 shows a UE 700 in accordance with some embodiments. As used herein, a UE refers to a device capable, configured, arranged, and/or operable to communicate wirelessly with network nodes and/or other UEs. Examples of a UE include, but are not limited to, a smart phone, mobile phone, cell phone, Voice over Internet Protocol (VoIP) phone, wireless local loop phone, desktop computer, Personal Digital Assistant (PDA), wireless camera, gaming console or device, music storage device, playback appliance, wearable terminal device, wireless endpoint, mobile station, tablet, laptop, Laptop Embedded Equipment (LEE), Laptop Mounted Equipment (LME), smart device, wireless Customer Premise Equipment (CPE), vehicle-mounted or vehicle embedded/integrated wireless device, etc. Other examples include any UE identified by the 3GPP, including a Narrowband Internet of Things (NB-IoT) UE, a Machine Type Communication (MTC) UE, and/or an enhanced MTC (eMTC) UE.

A UE may support Device-to-Device (D2D) communication, for example by implementing a 3GPP standard for sidelink communication, Dedicated Short-Range Communication (DSRC), Vehicle-to-Vehicle (V2V), Vehicle-to-Infrastructure (V2I), or Vehicle-to-Everything (V2X). In other examples, a UE may not necessarily have a user in the sense of a human user who owns and/or operates the relevant device. Instead, a UE may represent a device that is intended for sale to, or operation by, a human user but which may not, or which may not initially, be associated with a specific human user (e.g., a smart sprinkler controller). Alternatively, a UE may represent a device that is not intended for sale to, or operation by, an end user but which may be associated with or operated for the benefit of a user (e.g., a smart power meter).

The UE 700 includes processing circuitry 702 that is operatively coupled via a bus 704 to an input/output interface 706, a power source 708, memory 710, a communication interface 712, and/or any other component, or any combination thereof. Certain UEs may utilize all or a subset of the components shown in FIG. 7. The level of integration between the components may vary from one UE to another UE. Further, certain UEs may contain multiple instances of a component, such as multiple processors, memories, transceivers, transmitters, receivers, etc.

The processing circuitry 702 is configured to process instructions and data and may be configured to implement any sequential state machine operative to execute instructions stored as machine-readable computer programs in the memory 710. The processing circuitry 702 may be implemented as one or more hardware-implemented state machines (e.g., in discrete logic, Field Programmable Gate Arrays (FPGAs), Application Specific Integrated Circuits (ASICs), etc.); programmable logic together with appropriate firmware; one or more stored computer programs, general purpose processors, such as a microprocessor or Digital Signal Processor (DSP), together with appropriate software; or any combination of the above. For example, the processing circuitry 702 may include multiple Central Processing Units (CPUs).

In the example, the input/output interface 706 may be configured to provide an interface or interfaces to an input device, output device, or one or more input and/or output devices. Examples of an output device include a speaker, a sound card, a video card, a display, a monitor, a printer, an actuator, an emitter, a smartcard, another output device, or any combination thereof. An input device may allow a user to capture information into the UE 700. Examples of an input device include a touch-sensitive or presence-sensitive display, a camera (e.g., a digital camera, a digital video camera, a web camera, etc.), a microphone, a sensor, a mouse, a trackball, a directional pad, a trackpad, a scroll wheel, a smartcard, and the like. The presence-sensitive display may include a capacitive or resistive touch sensor to sense input from a user. A sensor may be, for instance, an accelerometer, a gyroscope, a tilt sensor, a force sensor, a magnetometer, an optical sensor, a proximity sensor, a biometric sensor, etc., or any combination thereof. An output device may use the same type of interface port as an input device. For example, a Universal Serial Bus (USB) port may be used to provide an input device and an output device.

In some embodiments, the power source 708 is structured as a battery or battery pack. Other types of power sources, such as an external power source (e.g., an electricity outlet), photovoltaic device, or power cell, may be used. The power source 708 may further include power circuitry for delivering power from the power source 708 itself, and/or an external power source, to the various parts of the UE 700 via input circuitry or an interface such as an electrical power cable. Delivering power may be, for example, for charging the power source 708. Power circuitry may perform any formatting, converting, or other modification to the power from the power source 708 to make the power suitable for the respective components of the UE 700 to which power is supplied.

The memory 710 may be or be configured to include memory such as Random Access Memory (RAM), Read Only Memory (ROM), Programmable ROM (PROM), Erasable PROM (EPROM), Electrically EPROM (EEPROM), magnetic disks, optical disks, hard disks, removable cartridges, flash drives, and so forth. In one example, the memory 710 includes one or more application programs 714, such as an operating system, web browser application, a widget, gadget engine, or other application, and corresponding data 716. The memory 710 may store, for use by the UE 700, any of a variety of various operating systems or combinations of operating systems.

The memory 710 may be configured to include a number of physical drive units, such as Redundant Array of Independent Disks (RAID), flash memory, USB flash drive, external hard disk drive, thumb drive, pen drive, key drive, High Density Digital Versatile Disc (HD-DVD) optical disc drive, internal hard disk drive, Blu-Ray optical disc drive, Holographic Digital Data Storage (HDDS) optical disc drive, external mini Dual In-line Memory Module (DIMM), Synchronous Dynamic RAM (SDRAM), external micro-DIMM SDRAM, smartcard memory such as a tamper resistant module in the form of a Universal Integrated Circuit Card (UICC) including one or more Subscriber Identity Modules (SIMs), such as a Universal SIM (USIM) and/or Internet Protocol Multimedia Services Identity Module (ISIM), other memory, or any combination thereof. The UICC may for example be an embedded UICC (eUICC), integrated UICC (iUICC) or a removable UICC commonly known as a ‘SIM card.’ The memory 710 may allow the UE 700 to access instructions, application programs, and the like stored on transitory or non-transitory memory media, to off-load data, or to upload data. An article of manufacture, such as one utilizing a communication system, may be tangibly embodied as or in the memory 710, which may be or comprise a device-readable storage medium.

The processing circuitry 702 may be configured to communicate with an access network or other network using the communication interface 712. The communication interface 712 may comprise one or more communication subsystems and may include or be communicatively coupled to an antenna 722. The communication interface 712 may include one or more transceivers used to communicate, such as by communicating with one or more remote transceivers of another device capable of wireless communication (e.g., another UE or a network node in an access network). Each transceiver may include a transmitter 718 and/or a receiver 720 appropriate to provide network communications (e.g., optical, electrical, frequency allocations, and so forth). Moreover, the transmitter 718 and receiver 720 may be coupled to one or more antennas (e.g., the antenna 722) and may share circuit components, software, or firmware, or alternatively be implemented separately.

In the illustrated embodiment, communication functions of the communication interface 712 may include cellular communication, WiFi communication, LPWAN communication, data communication, voice communication, multimedia communication, short-range communications such as Bluetooth, NFC, location-based communication such as the use of the Global Positioning System (GPS) to determine a location, another like communication function, or any combination thereof. Communications may be implemented according to one or more communication protocols and/or standards, such as IEEE 802.11, Code Division Multiplexing Access (CDMA), Wideband CDMA (WCDMA), GSM, LTE, NR, UMTS, WiMax, Ethernet, Transmission Control Protocol/Internet Protocol (TCP/IP), Synchronous Optical Networking (SONET), Asynchronous Transfer Mode (ATM), Quick User Datagram Protocol Internet Connection (QUIC), Hypertext Transfer Protocol (HTTP), and so forth.

Regardless of the type of sensor, a UE may provide an output of data captured by its sensors, through its communication interface 712, or via a wireless connection to a network node. Data captured by sensors of a UE can be communicated through a wireless connection to a network node via another UE. The output may be periodic (e.g., once every 15 minutes if it reports the sensed temperature), random (e.g., to even out the load from reporting from several sensors), in response to a triggering event (e.g., when moisture is detected an alert is sent), in response to a request (e.g., a user initiated request), or a continuous stream (e.g., a live video feed of a patient).

As another example, a UE comprises an actuator, a motor, or a switch related to a communication interface configured to receive wireless input from a network node via a wireless connection. In response to the received wireless input the states of the actuator, the motor, or the switch may change. For example, the UE may comprise a motor that adjusts the control surfaces or rotors of a drone in flight according to the received input or to a robotic arm performing a medical procedure according to the received input.

A UE, when in the form of an IoT device, may be a device for use in one or more application domains, these domains comprising, but not limited to, city wearable technology, extended industrial application, and healthcare. Non-limiting examples of such an IoT device are a device which is or which is embedded in: a connected refrigerator or freezer, a television, a connected lighting device, an electricity meter, a robot vacuum cleaner, a voice controlled smart speaker, a home security camera, a motion detector, a thermostat, a smoke detector, a door/window sensor, a flood/moisture sensor, an electrical door lock, a connected doorbell, an air conditioning system like a heat pump, an autonomous vehicle, a surveillance system, a weather monitoring device, a vehicle parking monitoring device, an electric vehicle charging station, a smart watch, a fitness tracker, a head-mounted display for Augmented Reality (AR) or VR, a wearable for tactile augmentation or sensory enhancement, a water sprinkler, an animal- or item-tracking device, a sensor for monitoring a plant or animal, an industrial robot, an Unmanned Aerial Vehicle (UAV), and any kind of medical device, like a heart rate monitor or a remote controlled surgical robot. A UE in the form of an IoT device comprises circuitry and/or software in dependence of the intended application of the IoT device in addition to other components as described in relation to the UE 700 shown in FIG. 7.

As yet another specific example, in an IoT scenario, a UE may represent a machine or other device that performs monitoring and/or measurements and transmits the results of such monitoring and/or measurements to another UE and/or a network node. The UE may in this case be an M2M device, which may in a 3GPP context be referred to as an MTC device. As one particular example, the UE may implement the 3GPP NB-IoT standard. In other scenarios, a UE may represent a vehicle, such as a car, a bus, a truck, a ship, an airplane, or other equipment that is capable of monitoring and/or reporting on its operational status or other functions associated with its operation.

In practice, any number of UEs may be used together with respect to a single use case. For example, a first UE might be or be integrated in a drone and provide the drone's speed information (obtained through a speed sensor) to a second UE that is a remote controller operating the drone. When the user makes changes from the remote controller, the first UE may adjust the throttle on the drone (e.g., by controlling an actuator) to increase or decrease the drone's speed. The first and/or the second UE can also include more than one of the functionalities described above. For example, a UE might comprise the sensor and the actuator and handle communication of data for both the speed sensor and the actuators.

FIG. 8 shows a network node 800 in accordance with some embodiments. As used herein, network node refers to equipment capable, configured, arranged, and/or operable to communicate directly or indirectly with a UE and/or with other network nodes or equipment in a telecommunication network. Examples of network nodes include, but are not limited to, APs (e.g., radio APs), Base Stations (BSs) (e.g., radio BSs, Node Bs, evolved Node Bs (eNBs), and NR Node Bs (gNBs)).

BSs may be categorized based on the amount of coverage they provide (or, stated differently, their transmit power level) and so, depending on the provided amount of coverage, may be referred to as femto BSs, pico BSs, micro BSs, or macro BSs. A BS may be a relay node or a relay donor node controlling a relay. A network node may also include one or more (or all) parts of a distributed radio BS such as centralized digital units and/or Remote Radio Units (RRUs), sometimes referred to as Remote Radio Heads (RRHs). Such RRUs may or may not be integrated with an antenna as an antenna integrated radio. Parts of a distributed radio BS may also be referred to as nodes in a Distributed Antenna System (DAS).

Other examples of network nodes include multiple Transmission Point (multi-TRP) 5G access nodes, Multi-Standard Radio (MSR) equipment such as MSR BSs, network controllers such as Radio Network Controllers (RNCs) or BS Controllers (BSCs), Base Transceiver Stations (BTSs), transmission points, transmission nodes, Multi-Cell/Multicast Coordination Entities (MCEs), Operation and Maintenance (O&M) nodes, Operations Support System (OSS) nodes, Self-Organizing Network (SON) nodes, positioning nodes (e.g., Evolved Serving Mobile Location Centers (E-SMLCs)), and/or Minimization of Drive Tests (MDTs).

The network node 800 includes processing circuitry 802, memory 804, a communication interface 806, and a power source 808. The network node 800 may be composed of multiple physically separate components (e.g., a Node B component and an RNC component, or a BTS component and a BSC component, etc.), which may each have their own respective components. In certain scenarios in which the network node 800 comprises multiple separate components (e.g., BTS and BSC components), one or more of the separate components may be shared among several network nodes. For example, a single RNC may control multiple Node Bs. In such a scenario, each unique Node B and RNC pair may in some instances be considered a single separate network node. In some embodiments, the network node 800 may be configured to support multiple RATs. In such embodiments, some components may be duplicated (e.g., separate memory 804 for different RATs) and some components may be reused (e.g., an antenna 810 may be shared by different RATs). The network node 800 may also include multiple sets of the various illustrated components for different wireless technologies integrated into network node 800, for example GSM, WCDMA, LTE, NR, WiFi, Zigbee, Z-wave, Long Range Wide Area Network (LoRaWAN), Radio Frequency Identification (RFID), or Bluetooth wireless technologies. These wireless technologies may be integrated into the same or different chip or set of chips and other components within the network node 800.

The processing circuitry 802 may comprise a combination of one or more of a microprocessor, controller, microcontroller, CPU, DSP, ASIC, FPGA, or any other suitable computing device, resource, or combination of hardware, software, and/or encoded logic operable to provide, either alone or in conjunction with other network node 800 components, such as the memory 804, to provide network node 800 functionality.

In some embodiments, the processing circuitry 802 includes a System on a Chip (SOC). In some embodiments, the processing circuitry 802 includes one or more of Radio Frequency (RF) transceiver circuitry 812 and baseband processing circuitry 814. In some embodiments, the RF transceiver circuitry 812 and the baseband processing circuitry 814 may be on separate chips (or sets of chips), boards, or units, such as radio units and digital units. In alternative embodiments, part or all of the RF transceiver circuitry 812 and the baseband processing circuitry 814 may be on the same chip or set of chips, boards, or units.

The memory 804 may comprise any form of volatile or non-volatile computer-readable memory including, without limitation, persistent storage, solid state memory, remotely mounted memory, magnetic media, optical media, RAM, ROM, mass storage media (for example, a hard disk), removable storage media (for example, a flash drive, a Compact Disk (CD), or a Digital Video Disk (DVD)), and/or any other volatile or non-volatile, non-transitory device-readable, and/or computer-executable memory devices that store information, data, and/or instructions that may be used by the processing circuitry 802. The memory 804 may store any suitable instructions, data, or information, including a computer program, software, an application including one or more of logic, rules, code, tables, and/or other instructions capable of being executed by the processing circuitry 802 and utilized by the network node 800. The memory 804 may be used to store any calculations made by the processing circuitry 802 and/or any data received via the communication interface 806. In some embodiments, the processing circuitry 802 and the memory 804 are integrated.

The communication interface 806 is used in wired or wireless communication of signaling and/or data between a network node, access network, and/or UE. As illustrated, the communication interface 806 comprises port(s)/terminal(s) 816 to send and receive data, for example to and from a network over a wired connection. The communication interface 806 also includes radio front-end circuitry 818 that may be coupled to, or in certain embodiments a part of, the antenna 810. The radio front-end circuitry 818 comprises filters 820 and amplifiers 822. The radio front-end circuitry 818 may be connected to the antenna 810 and the processing circuitry 802. The radio front-end circuitry 818 may be configured to condition signals communicated between the antenna 810 and the processing circuitry 802. The radio front-end circuitry 818 may receive digital data that is to be sent out to other network nodes or UEs via a wireless connection. The radio front-end circuitry 818 may convert the digital data into a radio signal having the appropriate channel and bandwidth parameters using a combination of the filters 820 and/or the amplifiers 822. The radio signal may then be transmitted via the antenna 810. Similarly, when receiving data, the antenna 810 may collect radio signals which are then converted into digital data by the radio front-end circuitry 818. The digital data may be passed to the processing circuitry 802. In other embodiments, the communication interface 806 may comprise different components and/or different combinations of components.

In certain alternative embodiments, the network node 800 does not include separate radio front-end circuitry 818; instead, the processing circuitry 802 includes radio front-end circuitry and is connected to the antenna 810. Similarly, in some embodiments, all or some of the RF transceiver circuitry 812 is part of the communication interface 806. In still other embodiments, the communication interface 806 includes the one or more ports or terminals 816, the radio front-end circuitry 818, and the RF transceiver circuitry 812 as part of a radio unit (not shown), and the communication interface 806 communicates with the baseband processing circuitry 814, which is part of a digital unit (not shown).

The antenna 810 may include one or more antennas, or antenna arrays, configured to send and/or receive wireless signals. The antenna 810 may be coupled to the radio front-end circuitry 818 and may be any type of antenna capable of transmitting and receiving data and/or signals wirelessly. In certain embodiments, the antenna 810 is separate from the network node 800 and connectable to the network node 800 through an interface or port.

The antenna 810, the communication interface 806, and/or the processing circuitry 802 may be configured to perform any receiving operations and/or certain obtaining operations described herein as being performed by the network node 800. Any information, data, and/or signals may be received from a UE, another network node, and/or any other network equipment. Similarly, the antenna 810, the communication interface 806, and/or the processing circuitry 802 may be configured to perform any transmitting operations described herein as being performed by the network node 800. Any information, data, and/or signals may be transmitted to a UE, another network node, and/or any other network equipment.

The power source 808 provides power to the various components of the network node 800 in a form suitable for the respective components (e.g., at a voltage and current level needed for each respective component). The power source 808 may further comprise, or be coupled to, power management circuitry to supply the components of the network node 800 with power for performing the functionality described herein. For example, the network node 800 may be connectable to an external power source (e.g., the power grid or an electricity outlet) via input circuitry or an interface such as an electrical cable, whereby the external power source supplies power to power circuitry of the power source 808. As a further example, the power source 808 may comprise a source of power in the form of a battery or battery pack which is connected to, or integrated in, power circuitry. The battery may provide backup power should the external power source fail.

Embodiments of the network node 800 may include additional components beyond those shown in FIG. 8 for providing certain aspects of the network node's functionality, including any of the functionality described herein and/or any functionality necessary to support the subject matter described herein. For example, the network node 800 may include user interface equipment to allow input of information into the network node 800 and to allow output of information from the network node 800. This may allow a user to perform diagnostic, maintenance, repair, and other administrative functions for the network node 800.

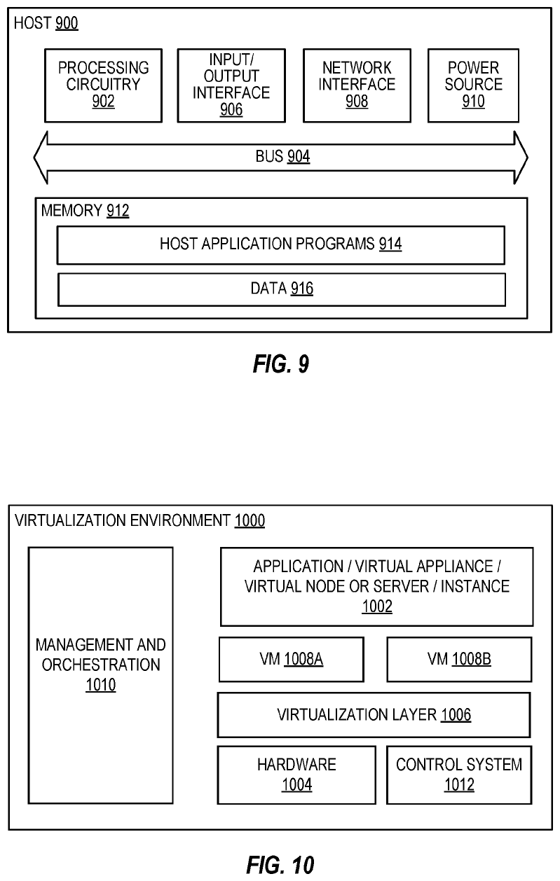

FIG. 9 is a block diagram of a host 900, which may be an embodiment of the host 616 of FIG. 6, in accordance with various aspects described herein. As used herein, the host 900 may be or comprise various combinations of hardware and/or software including a standalone server, a blade server, a cloud-implemented server, a distributed server, a virtual machine, container, or processing resources in a server farm. The host 900 may provide one or more services to one or more UEs.

The host 900 includes processing circuitry 902 that is operatively coupled via a bus 904 to an input/output interface 906, a network interface 908, a power source 910, and memory 912. Other components may be included in other embodiments. Features of these components may be substantially similar to those described with respect to the devices of previous figures, such as FIGS. 7 and 8, such that the descriptions thereof are generally applicable to the corresponding components of the host 900.

The memory 912 may include one or more computer programs including one or more host application programs 914 and data 916, which may include user data, e.g., data generated by a UE for the host 900 or data generated by the host 900 for a UE. Embodiments of the host 900 may utilize only a subset or all of the components shown. The host application programs 914 may be implemented in a container-based architecture and may provide support for video codecs (e.g., Versatile Video Coding (VVC), High Efficiency Video Coding (HEVC), Advanced Video Coding (AVC), Moving Picture Experts Group (MPEG), VP9) and audio codecs (e.g., Free Lossless Audio Codec (FLAC), Advanced Audio Coding (AAC), MPEG, G.711), including transcoding for multiple different classes, types, or implementations of UEs (e.g., handsets, desktop computers, wearable display systems, and heads-up display systems). The host application programs 914 may also provide for user authentication and licensing checks and may periodically report health, routes, and content availability to a central node, such as a device in or on the edge of a core network. Accordingly, the host 900 may select and/or indicate a different host for Over-The-Top (OTT) services for a UE. The host application programs 914 may support various protocols, such as the HTTP Live Streaming (HLS) protocol, Real-Time Messaging Protocol (RTMP), Real-Time Streaming Protocol (RTSP), Dynamic Adaptive Streaming over HTTP (DASH or MPEG-DASH), etc.

FIG. 10 is a block diagram illustrating a virtualization environment 1000 in which functions implemented by some embodiments may be virtualized. In the present context, virtualizing means creating virtual versions of apparatuses or devices which may include virtualizing hardware platforms, storage devices, and networking resources. As used herein, virtualization can be applied to any device described herein, or components thereof, and relates to an implementation in which at least a portion of the functionality is implemented as one or more virtual components. Some or all of the functions described herein may be implemented as virtual components executed by one or more Virtual Machines (VMs) implemented in one or more virtual environments 1000 hosted by one or more of hardware nodes, such as a hardware computing device that operates as a network node, UE, core network node, or host. Further, in embodiments in which the virtual node does not require radio connectivity (e.g., a core network node or host), then the node may be entirely virtualized.

Applications 1002 (which may alternatively be called software instances, virtual appliances, network functions, virtual nodes, virtual network functions, etc.) are run in the virtualization environment 1000 to implement some of the features, functions, and/or benefits of some of the embodiments disclosed herein.

Hardware 1004 includes processing circuitry, memory that stores software and/or instructions executable by hardware processing circuitry, and/or other hardware devices as described herein, such as a network interface, input/output interface, and so forth. Software may be executed by the processing circuitry to instantiate one or more virtualization layers 1006 (also referred to as hypervisors or VM Monitors (VMMs)), provide VMs 1008A and 1008B (one or more of which may be generally referred to as VMs 1008), and/or perform any of the functions, features, and/or benefits described in relation with some embodiments described herein. The virtualization layer 1006 may present a virtual operating platform that appears like networking hardware to the VMs 1008.

The VMs 1008 comprise virtual processing, virtual memory, virtual networking, or interface and virtual storage, and may be run by a corresponding virtualization layer 1006. Different embodiments of the instance of a virtual appliance 1002 may be implemented on one or more of the VMs 1008, and the implementations may be made in different ways. Virtualization of the hardware is in some contexts referred to as Network Function Virtualization (NFV). NFV may be used to consolidate many network equipment types onto industry standard high volume server hardware, physical switches, and physical storage, which can be located in data centers and customer premise equipment.

In the context of NFV, a VM 1008 may be a software implementation of a physical machine that runs programs as if they were executing on a physical, non-virtualized machine. Each of the VMs 1008, and that part of the hardware 1004 that executes that VM, be it hardware dedicated to that VM and/or hardware shared by that VM with others of the VMs 1008, forms separate virtual network elements. Still in the context of NFV, a virtual network function is responsible for handling specific network functions that run in one or more VMs 1008 on top of the hardware 1004 and corresponds to the application 1002.

The hardware 1004 may be implemented in a standalone network node with generic or specific components. The hardware 1004 may implement some functions via virtualization. Alternatively, the hardware 1004 may be part of a larger cluster of hardware (e.g., such as in a data center or CPE) where many hardware nodes work together and are managed via management and orchestration 1010, which, among others, oversees lifecycle management of the applications 1002. In some embodiments, the hardware 1004 is coupled to one or more radio units that each include one or more transmitters and one or more receivers that may be coupled to one or more antennas. Radio units may communicate directly with other hardware nodes via one or more appropriate network interfaces and may be used in combination with the virtual components to provide a virtual node with radio capabilities, such as a RAN or a BS. In some embodiments, some signaling can be provided with the use of a control system 1012 which may alternatively be used for communication between hardware nodes and radio units.

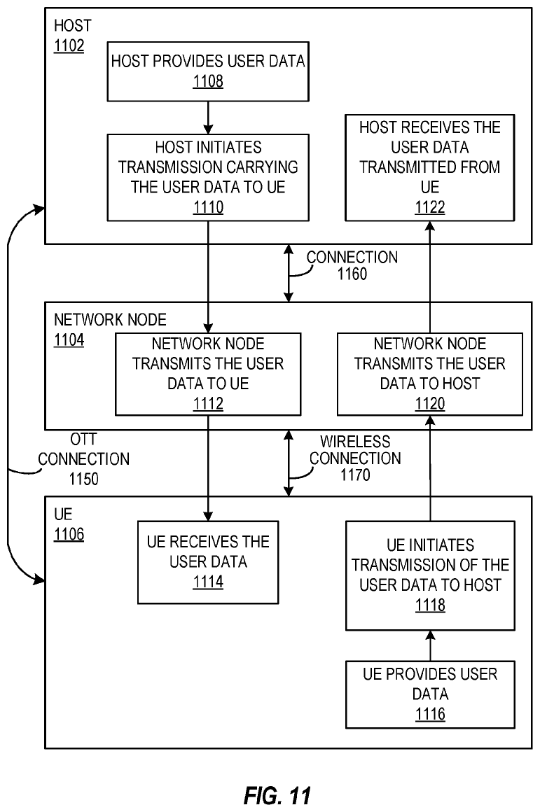

FIG. 11 shows a communication diagram of a host 1102 communicating via a network node 1104 with a UE 1106 over a partially wireless connection in accordance with some embodiments. Example implementations, in accordance with various embodiments, of the UE (such as the UE 612A of FIG. 6 and/or the UE 700 of FIG. 7), the network node (such as the network node 610A of FIG. 6 and/or the network node 800 of FIG. 8), and the host (such as the host 616 of FIG. 6 and/or the host 900 of FIG. 9) discussed in the preceding paragraphs will now be described with reference to FIG. 11.

Like the host 900, embodiments of the host 1102 include hardware, such as a communication interface, processing circuitry, and memory. The host 1102 also includes software, which is stored in or is accessible by the host 1102 and executable by the processing circuitry. The software includes a host application that may be operable to provide a service to a remote user, such as the UE 1106 connecting via an OTT connection 1150 extending between the UE 1106 and the host 1102. In providing the service to the remote user, a host application may provide user data which is transmitted using the OTT connection 1150.

The network node 1104 includes hardware enabling it to communicate with the host 1102 and the UE 1106 via a connection 1160. The connection 1160 may be direct or pass through a core network (like the core network 606 of FIG. 6) and/or one or more other intermediate networks, such as one or more public, private, or hosted networks. For example, an intermediate network may be a backbone network or the Internet.

The UE 1106 includes hardware and software, which is stored in or accessible by the UE 1106 and executable by the UE's processing circuitry. The software includes a client application, such as a web browser or operator-specific “app” that may be operable to provide a service to a human or non-human user via the UE 1106 with the support of the host 1102. In the host 1102, an executing host application may communicate with the executing client application via the OTT connection 1150 terminating at the UE 1106 and the host 1102. In providing the service to the user, the UE's client application may receive request data from the host's host application and provide user data in response to the request data. The OTT connection 1150 may transfer both the request data and the user data. The UE's client application may interact with the user to generate the user data that it provides to the host application through the OTT connection 1150.

The OTT connection 1150 may extend via the connection 1160 between the host 1102 and the network node 1104 and via a wireless connection 1170 between the network node 1104 and the UE 1106 to provide the connection between the host 1102 and the UE 1106. The connection 1160 and the wireless connection 1170, over which the OTT connection 1150 may be provided, have been drawn abstractly to illustrate the communication between the host 1102 and the UE 1106 via the network node 1104, without explicit reference to any intermediary devices and the precise routing of messages via these devices.

As an example of transmitting data via the OTT connection 1150, in step 1108, the host 1102 provides user data, which may be performed by executing a host application. In some embodiments, the user data is associated with a particular human user interacting with the UE 1106. In other embodiments, the user data is associated with a UE 1106 that shares data with the host 1102 without explicit human interaction. In step 1110, the host 1102 initiates a transmission carrying the user data towards the UE 1106. The host 1102 may initiate the transmission responsive to a request transmitted by the UE 1106. The request may be caused by human interaction with the UE 1106 or by operation of the client application executing on the UE 1106. The transmission may pass via the network node 1104 in accordance with the teachings of the embodiments described throughout this disclosure. Accordingly, in step 1112, the network node 1104 transmits to the UE 1106 the user data that was carried in the transmission that the host 1102 initiated, in accordance with the teachings of the embodiments described throughout this disclosure. In step 1114, the UE 1106 receives the user data carried in the transmission, which may be performed by a client application executed on the UE 1106 associated with the host application executed by the host 1102.

In some examples, the UE 1106 executes a client application which provides user data to the host 1102. The user data may be provided in reaction or response to the data received from the host 1102. Accordingly, in step 1116, the UE 1106 may provide user data, which may be performed by executing the client application. In providing the user data, the client application may further consider user input received from the user via an input/output interface of the UE 1106. Regardless of the specific manner in which the user data was provided, the UE 1106 initiates, in step 1118, transmission of the user data towards the host 1102 via the network node 1104. In step 1120, in accordance with the teachings of the embodiments described throughout this disclosure, the network node 1104 receives user data from the UE 1106 and initiates transmission of the received user data towards the host 1102. In step 1122, the host 1102 receives the user data carried in the transmission initiated by the UE 1106.

One or more of the various embodiments improve the performance of OTT services provided to the UE 1106 using the OTT connection 1150, in which the wireless connection 1170 forms the last segment. More precisely, the teachings of these embodiments may improve the e.g., data rate, latency, power consumption, etc. and thereby provide benefits such as e.g., reduced user waiting time, relaxed restriction on file size, improved content resolution, better responsiveness, extended battery lifetime, etc.

In an example scenario, factory status information may be collected and analyzed by the host 1102. As another example, the host 1102 may process audio and video data which may have been retrieved from a UE for use in creating maps. As another example, the host 1102 may collect and analyze real-time data to assist in controlling vehicle congestion (e.g., controlling traffic lights). As another example, the host 1102 may store surveillance video uploaded by a UE. As another example, the host 1102 may store or control access to media content such as video, audio, VR, or AR which it can broadcast, multicast, or unicast to UEs. As other examples, the host 1102 may be used for energy pricing, remote control of non-time critical electrical load to balance power generation needs, location services, presentation services (such as compiling diagrams etc. from data collected from remote devices), or any other function of collecting, retrieving, storing, analyzing, and/or transmitting data.

In some examples, a measurement procedure may be provided for the purpose of monitoring data rate, latency, and other factors on which the one or more embodiments improve. There may further be an optional network functionality for reconfiguring the OTT connection 1150 between the host 1102 and the UE 1106 in response to variations in the measurement results. The measurement procedure and/or the network functionality for reconfiguring the OTT connection 1150 may be implemented in software and hardware of the host 1102 and/or the UE 1106. In some embodiments, sensors (not shown) may be deployed in or in association with other devices through which the OTT connection 1150 passes; the sensors may participate in the measurement procedure by supplying values of the monitored quantities exemplified above, or by supplying values of other physical quantities from which software may compute or estimate the monitored quantities. The reconfiguring of the OTT connection 1150 may include message format, retransmission settings, preferred routing, etc.; the reconfiguring need not directly alter the operation of the network node 1104. Such procedures and functionalities may be known and practiced in the art. In certain embodiments, measurements may involve proprietary UE signaling that facilitates measurements of throughput, propagation times, latency, and the like by the host 1102. The measurements may be implemented in that software causes messages to be transmitted, in particular empty or ‘dummy’ messages, using the OTT connection 1150 while monitoring propagation times, errors, etc.

Although the computing devices described herein (e.g., UEs, network nodes, hosts) may include the illustrated combination of hardware components, other embodiments may comprise computing devices with different combinations of components. It is to be understood that these computing devices may comprise any suitable combination of hardware and/or software needed to perform the tasks, features, functions, and methods disclosed herein. Determining, calculating, obtaining, or similar operations described herein may be performed by processing circuitry, which may process information by, for example, converting the obtained information into other information, comparing the obtained information or converted information to information stored in the network node, and/or performing one or more operations based on the obtained information or converted information, and as a result of said processing making a determination. Moreover, while components are depicted as single boxes located within a larger box or nested within multiple boxes, in practice computing devices may comprise multiple different physical components that make up a single illustrated component, and functionality may be partitioned between separate components. For example, a communication interface may be configured to include any of the components described herein, and/or the functionality of the components may be partitioned between the processing circuitry and the communication interface. In another example, non-computationally intensive functions of any of such components may be implemented in software or firmware and computationally intensive functions may be implemented in hardware.

In certain embodiments, some or all of the functionality described herein may be provided by processing circuitry executing instructions stored in memory, which in certain embodiments may be a computer program product in the form of a non-transitory computer-readable storage medium. In alternative embodiments, some or all of the functionality may be provided by the processing circuitry without executing instructions stored on a separate or discrete device-readable storage medium, such as in a hardwired manner. In any of those particular embodiments, whether executing instructions stored on a non-transitory computer-readable storage medium or not, the processing circuitry can be configured to perform the described functionality. The benefits provided by such functionality are not limited to the processing circuitry alone or to other components of the computing device, but are enjoyed by the computing device as a whole and/or by end users and a wireless network generally.

### EMBODIMENTS

### Group A Embodiments

Embodiment 1: A method performed by a user equipment for determining a power adjustment, the method comprising: a. determining (400) a PUCCH power adjustment with respect to a PUCCH format and/or Transport Format, TF.

Embodiment 2: The method of embodiment 1 wherein determining the PUCCH power adjustment is based on one or more out of: a UCI consists of UCI with same priority index or different priority indices; a number of high-priority and/or low-priority UCI bits; minimum of high-priority and low-priority UCI bits.

Embodiment 3: The method of any of the previous embodiments further comprising any of the steps or features described herein.

Embodiment 4: The method of any of the previous embodiments, further comprising: providing user data; and forwarding the user data to a host via the transmission to the network node.

### Group B Embodiments

Embodiment 5: A method performed by a network node for enabling a power adjustment, the method comprising: a. configuring (500) a user equipment to determine a PUCCH power adjustment with respect to a PUCCH format and/or Transport Format, TF.

Embodiment 6: The method of embodiment 5 wherein determining the PUCCH power adjustment is based on one or more out of: a UCI consists of UCI with same priority index or different priority indices; a number of high-priority and/or low-priority UCI bits; minimum of high-priority and low-priority UCI bits.

Embodiment 7: The method of any of the previous embodiments further comprising any of the steps or features described herein.

Embodiment 8: The method of any of the previous embodiments, further comprising: obtaining user data; and forwarding the user data to a host or a user equipment.

### Group C Embodiments

Embodiment 9: A user equipment for determining a power adjustment, comprising: processing circuitry configured to perform any of the steps of any of the Group A embodiments; and power supply circuitry configured to supply power to the processing circuitry.

Embodiment 10: A network node for enabling a power adjustment, the network node comprising: processing circuitry configured to perform any of the steps of any of the Group B embodiments; power supply circuitry configured to supply power to the processing circuitry.

Embodiment 11: A user equipment (UE) for determining a power adjustment, the UE comprising:
an antenna configured to send and receive wireless signals; radio front-end circuitry connected to the antenna and to processing circuitry, and configured to condition signals communicated between the antenna and the processing circuitry; the processing circuitry being configured to perform any of the steps of any of the Group A embodiments; an input interface connected to the processing circuitry and configured to allow input of information into the UE to be processed by the processing circuitry; an output interface connected to the processing circuitry and configured to output information from the UE that has been processed by the processing circuitry; and a battery connected to the processing circuitry and configured to supply power to the UE.

Embodiment 12: A host configured to operate in a communication system to provide an over-the-top (OTT) service, the host comprising: processing circuitry configured to provide user data; and a network interface configured to initiate transmission of the user data to a cellular network for transmission to a user equipment (UE), wherein the UE comprises a communication interface and processing circuitry, the communication interface and processing circuitry of the UE being configured to perform any of the steps of any of the Group A embodiments to receive the user data from the host.

Embodiment 13: The host of the previous embodiment, wherein the cellular network further includes a network node configured to communicate with the UE to transmit the user data to the UE from the host.

Embodiment 14: The host of the previous 2 embodiments, wherein: the processing circuitry of the host is configured to execute a host application, thereby providing the user data; and the host application is configured to interact with a client application executing on the UE, the client application being associated with the host application.

Embodiment 15: A method implemented by a host operating in a communication system that further includes a network node and a user equipment (UE), the method comprising: providing user data for the UE; and initiating a transmission carrying the user data to the UE via a cellular network comprising the network node, wherein the UE performs any of the operations of any of the Group A embodiments to receive the user data from the host.

Embodiment 16: The method of the previous embodiment, further comprising: at the host, executing a host application associated with a client application executing on the UE to receive the user data from the UE.

Embodiment 17: The method of the previous embodiment, further comprising: at the host, transmitting input data to the client application executing on the UE, the input data being provided by executing the host application, wherein the user data is provided by the client application in response to the input data from the host application.

Embodiment 18: A host configured to operate in a communication system to provide an over-the-top (OTT) service, the host comprising: processing circuitry configured to provide user data; and a network interface configured to initiate transmission of the user data to a cellular network for transmission to a user equipment (UE),
wherein the UE comprises a communication interface and processing circuitry, the communication interface and processing circuitry of the UE being configured to perform any of the steps of any of the Group A embodiments to transmit the user data to the host.

Embodiment 19: The host of the previous embodiment, wherein the cellular network further includes a network node configured to communicate with the UE to transmit the user data from the UE to the host.

Embodiment 20: The host of the previous 2 embodiments, wherein: the processing circuitry of the host is configured to execute a host application, thereby providing the user data; and the host application is configured to interact with a client application executing on the UE, the client application being associated with the host application.

Embodiment 21: A method implemented by a host configured to operate in a communication system that further includes a network node and a user equipment (UE), the method comprising: at the host, receiving user data transmitted to the host via the network node by the UE, wherein the UE performs any of the steps of any of the Group A embodiments to transmit the user data to the host.

Embodiment 22: The method of the previous embodiment, further comprising: at the host, executing a host application associated with a client application executing on the UE to receive the user data from the UE.

Embodiment 23: The method of the previous embodiment, further comprising: at the host, transmitting input data to the client application executing on the UE, the input data being provided by executing the host application, wherein the user data is provided by the client application in response to the input data from the host application.

Embodiment 24: A host configured to operate in a communication system to provide an over-the-top (OTT) service, the host comprising: processing circuitry configured to provide user data; and a network interface configured to initiate transmission of the user data to a network node in a cellular network for transmission to a user equipment (UE), the network node having a communication interface and processing circuitry, the processing circuitry of the network node configured to perform any of the operations of any of the Group B embodiments to transmit the user data from the host to the UE.

Embodiment 25: The host of the previous embodiment, wherein: the processing circuitry of the host is configured to execute a host application that provides the user data; and the UE comprises processing circuitry configured to execute a client application associated with the host application to receive the transmission of user data from the host.

Embodiment 26: A method implemented in a host configured to operate in a communication system that further includes a network node and a user equipment (UE), the method comprising: providing user data for the UE; and initiating a transmission carrying the user data to the UE via a cellular network comprising the network node, wherein the network node performs any of the operations of any of the Group B embodiments to transmit the user data from the host to the UE.

Embodiment 27: The method of the previous embodiment, further comprising, at the network node, transmitting the user data provided by the host for the UE.

Embodiment 28: The method of any of the previous 2 embodiments, wherein the user data is provided at the host by executing a host application that interacts with a client application executing on the UE, the client application being associated with the host application.

Embodiment 29: A communication system configured to provide an over-the-top service, the communication system comprising: a host comprising: processing circuitry configured to provide user data for a user equipment (UE), the user data being associated with the over-the-top service; and a network interface configured to initiate transmission of the user data toward a cellular network node for transmission to the UE, the network node having a communication interface and processing circuitry, the processing circuitry of the network node configured to perform any of the operations of any of the Group B embodiments to transmit the user data from the host to the UE.

Embodiment 30: The communication system of the previous embodiment, further comprising: the network node; and/or the user equipment.

Embodiment 31: A host configured to operate in a communication system to provide an over-the-top (OTT) service, the host comprising: processing circuitry configured to initiate receipt of user data; and a network interface configured to receive the user data from a network node in a cellular network, the network node having a communication interface and processing circuitry, the processing circuitry of the network node configured to perform any of the operations of any of the Group B embodiments to receive the user data from a user equipment (UE) for the host.

Embodiment 32: The host of the previous 2 embodiments, wherein: the processing circuitry of the host is configured to execute a host application, thereby providing the user data; and the host application is configured to interact with a client application executing on the UE, the client application being associated with the host application.

Embodiment 33: The host of the any of the previous 2 embodiments, wherein the initiating receipt of the user data comprises requesting the user data.

Embodiment 34: A method implemented by a host configured to operate in a communication system that further includes a network node and a user equipment (UE), the method comprising: at the host, initiating receipt of user data from the UE, the user data originating from a transmission which the network node has received from the UE, wherein the network node performs any of the steps of any of the Group B embodiments to receive the user data from the UE for the host.

Embodiment 35: The method of the previous embodiment, further comprising at the network node, transmitting the received user data to the host.

Those skilled in the art will recognize improvements and modifications to the embodiments of the present disclosure. All such improvements and modifications are considered within the scope of the concepts disclosed herein.

1. A method performed by a User Equipment (UE) for determining a power adjustment, the method comprising:
determining a Physical Uplink Control Channel (PUCCH) power adjustment with respect to a PUCCH format and/or Transport Format (TF);
wherein determining the PUCCH power adjustment is based on one or more out of:
Uplink Control Information (UCI) consists of UCI with a same priority index or different priority indices;
a number of high-priority and/or low-priority UCI bits; and
a minimum of high-priority and low-priority UCI bits, and
wherein the UCI bits comprise Hybrid Automatic Repeat Request Acknowledgement (HARQ-ACK) information bits.

2. The method of claim 1 wherein determining the PUCCH power adjustment comprises:
if a PUCCH includes UCI bits of high-priority and low-priority, determining the PUCCH power adjustment assuming that all UCI bits have high-priority.

3. (canceled)

4. (canceled)

5. The method of claim 1 further comprising:
transmitting the PUCCH according to the determined PUCCH power adjustment.

6. The method of claim 1 wherein the UCI bits are separately coded, or are jointly coded, before mapping to the PUCCH.

7. The method of claim 1 further comprising:
two deltaF-PUCCH-fX for PUCCH format X, where a first (or second) value is used to determine Δ_{F_PUCCH}(F) when the UCI consists of UCI bits with different priority indices and the second (or first) value is used when the UCI consists of UCI bits all having the same priority index.

8. The method of claim 1 wherein receiving the two deltaF-PUCCH-fX values for PUCCH format X comprises receiving an extended Radio Resource Control (RRC), Information Element (IE), PUCCH-PowerControl.

9. The method of claim 1 wherein determining the PUCCH power adjustment comprises: adjusting the Δ_{TF,b,f,c}(i) term in the PUCCH power control formula.

10. The method of claim 9 wherein the formula for calculating Δ_{TF,b,f,c}(i) is selected as a function of a number of a subset of the UCI bits instead of the total number of UCI bits carried by the PUCCH.

11. The method of claim 10 wherein the subset of the UCI bits refers to the high priority UCI bits.

12. The method of claim 1 wherein, when the UCI bits carried by the PUCCH are divided into two (or more) parts, and separate coding is applied to each part, then the subset of the UCI bits refers to the number of UCI bits in one part.

13. A method performed by a network node for determining a power adjustment, the method comprising:
configuring a User Equipment (UE) to determine a Physical Uplink Control Channel (PUCCH) power adjustment with respect to a PUCCH format and/or Transport Format (TF);
wherein determining the PUCCH power adjustment is based on one or more out of:
Uplink Control Information (UCI) consisting of UCI with a same priority index or different priority indices;
a number of high-priority and/or low-priority UCI bits; and
a minimum of high-priority and low-priority UCI bits, and
wherein the UCI bits comprise Hybrid Automatic Repeat Request Acknowledgement (HARQ-ACK) information bits.

14. The method of claim 13 wherein determining the PUCCH power adjustment comprises:
if a PUCCH includes UCI bits of high-priority and low-priority, determining the PUCCH power adjustment assuming that all UCI bits have high-priority.

15. (canceled)

16. (canceled)

17. The method of claim 13 further comprising:
transmitting the PUCCH according to the determined PUCCH power adjustment.

18. The method of claim 13 wherein the UCI bits are separately coded or are jointly coded before mapping to the PUCCH.

19. The method of claim 13 further comprising:
two deltaF-PUCCH-fX for PUCCH format X, where a first (or second) value is used to determine Δ_{F_PUCCH}(F) when the UCI consists of UCI bits with different priority indices and a second (or first) value is used when the UCI consists of UCI bits all having the same priority index.

20. The method of claim 13 wherein receiving the two deltaF-PUCCH-fX values for PUCCH format X comprises receiving an extended Radio Resource Control, RRC, Information Element (IE) PUCCH-PowerControl.

21. The method of claim 13 wherein determining the PUCCH power adjustment comprises: adjusting the Δ_{TF,b,f,c}(i) term in the PUCCH power control formula.

22. The method of claim 21 wherein the formula for calculating Δ_{TF,b,f,c}(i) is selected as a function of a number of a subset of the UCI bits instead of the total number of UCI bits carried by the PUCCH.

23. The method of claim 22 wherein the subset of the UCI bits refers to the high priority UCI bits.

24. The method of claim 13 wherein, when the UCI bits carried by the PUCCH are divided into two (or more) parts, and separate coding is applied to each part, then the subset of the UCI bits refers to the number of UCI bits in one part.

25. A wireless device comprising:
processing circuitry, the processing circuitry configured to cause the wireless device to:
determine a Physical Uplink Control Channel (PUCCH) power adjustment with respect to a PUCCH format and/or Transport Format (TF);
wherein determining the PUCCH power adjustment is based on one or more out of:
Uplink Control Information (UCI) consists of UCI with same priority index or different priority indices;
a number of high-priority and/or low-priority UCI bits; and
a minimum of high-priority and low-priority UCI bits.

26. (canceled)

27. (canceled)

28. (canceled)
